(19) United States
(12) Patent Application Publication
(10) Pub. No.: US 2006/0221097 A1
(43) Pub. Date: Oct. 5, 2006

(54) Display data generation device, display automatic operation data generation device, display data generation method, display automatic operation data generation method, display data generation program, display automatic operation data generation program, and computer-readable recording medium containing these programs

(75) Inventors: Kensaku Kagechi, Nara-shi (JP); Keisuke Iwasaki, Ikoma-gun (JP); Hisashi Saiga, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/444,455

(22) Filed: Jun. 1, 2006

Related U.S. Application Data
(63) Continuation of application No. PCT/JP04/17718, filed on Nov. 29, 2004.

(30) Foreign Application Priority Data
Dec. 5, 2003 (JP) 2003-407528 (P)
Dec. 5, 2003 (JP) 2003-407598 (P)
Aug. 31, 2004 (JP) 2004-252476 (P)
Sep. 6, 2004 (JP) 2004-258751 (P)

(51) Int. Cl. G09G 5/00

(52) U.S. Cl. 345/619

(57) ABSTRACT

An image automatic display device for reading automatic operation data as one of pieces of input data has a display image data generation device and a display image data generation operation processing unit. The display image data generation device generates image data to be displayed on a display device on the basis of image data read out from an image input device. The display image data generation operation processing unit controls the display image data generation device by using user operation input data inputted through a viewer operation input device and the automatic operation data. The automatic operation data has a plurality of sets of values of various parameters used for generating an image to be displayed. A user performs an operation through the viewer operation input device, so that a desired set to be applied for image generation is designated in the automatic operation data.

This application is a continuation of International Application No. PCT/JP2004/017718, whose international filing date is Nov. 29, 2004, which in turn claims the benefit of Japanese Patent Applications Nos. 2003-407528, 2003-407598, 2004-252476, and 2004-258751, filed Dec. 5, 2003, Dec. 5, 2003, Aug. 31, 2004, and Sep. 6, 2004, respectively, the disclosure of which Applications is incorporated by reference herein. The benefit of the filing and priority dates of the International and Japanese Applications is respectfully requested.

### BACKGROUND OF THE INVENTION

1. Field of the Invention

The present invention relates to a display data generation device, a display automatic operation data generation device, a display data generation method, a display automatic operation data generation method, a display data generation program, a display automatic operation data generation program, and a computer-readable recording medium containing these programs. In particular, the present invention relates to a display data generation device, a display automatic operation data generation device, a display data generation method, a display automatic operation data generation method, a display data generation program, a display automatic operation data generation program, and a computer-readable recording medium containing these programs, that provide display data viewable while grasping layouts of a document and an image on a small display region or a display part with low resolution.

2. Description of the Background Art

Along with popularization and improvement in performance of mobile terminals such as a mobile telephone and a PDA (Personal Digital Assistant), complicated information can be treated in these mobile terminals in recent years. In the conventional art, if such a mobile terminal, for example, a terminal having a small display region or a display part with low resolution displays a document with high resolution or a document having a complicated layout, a character is displayed on a screen so that a size thereof is enlarged or reduced for the sake of facilitation of reading. A user operates the display region of the screen with the use of a pointing device or keys for instructions in upward, downward, leftward and rightward directions to thereby pursue the reading of the document.

In this technique, a document generator and a document user both incur the following problems. There is a high possibility that a portion on which the document generator places prime importance is overlooked depending on the operation by the user, so that the generator cannot correctly inform the user details as intended. In addition, if the layout of the document is complicated, the user must operate the display region while taking a sequence into consideration and pursue the reading of the document. This hinders the user from concentrating on the reading of the details of the document.

In order to solve these problems, there is conventionally proposed a device that allows a viewer system to have data for automatically controlling a display operation originally performed by a user and displays a document on the basis of the automatic operation data (refer to, for example, Japanese Patent Laying-Open No. 11-272399).

According to the device disclosed in Japanese Patent Laying-Open No. 11-272399, an electronic book is flexibly scroll-displayed. Therefore, when an electronic book generator previously writes desired scrolling procedures to electronic book data, a scroll-display operation in accordance with the procedures assumed by the generator is performed only by repetition of a single operation by a user at the time when the user reads the electronic book.

On the other hand, in Japanese Patent Laying-Open No. 2001-84075, a line read by a user is connected with a subsequent line upon display. Further, only an attention line (a line that the user is reading) is displayed in an enlargement manner.

### SUMMARY OF THE INVENTION

In the method disclosed in Japanese Patent Laying-Open No. 11-272399, the scroll-display operation is performed in accordance with the procedures assumed by the generator. However, since there are a plurality of lines within a display range, the user does not necessarily read a line assumed by the generator. This causes the following drawback: a line that the user wants to read is not displayed due to a change in display position, such as a line break, in some cases. For example, in the case where there are five lines within the display range and the generator assumes that the user reads a central third line, it is sufficient that a fourth line is displayed after a line break. However, the user may possibly read a first line. In this case, a second line must be displayed after a line break; however, there is no assurance that the second line is displayed.

There is also a drawback that the user misses a portion to be read in the entire document, so that the user reads the document in defiance of a layout.

In addition, for example, when the display region shifts from a right edge of a line end to a left edge of a line head, the user does not necessarily recognize a line subsequent to a line, that he/she is reading, correctly from among a plurality of displayed lines. In other words, the user must read the document while presuming a line to be read on the basis of a context of the document.

Moreover, it is difficult for the user to grasp the entirety of a page and to readily find a position to be read in the page.

In the method disclosed in Japanese Patent Laying-Open No. 2001-84075, it is impossible to maintain an original layout of a document to be displayed (a document around a line that the user is reading).

Accordingly, an object of the present invention is to provide a display data generation device, a display data generation method, a display data generation program, and a computer-readable recording medium containing the display data generation program, each capable of generating, by a simple operation, display data intended by a generator or display data which is readily read by a user and has a layout readily grasped by the user.

Another object of the present invention is to provide a display automatic operation data generation device, a display automatic operation data generation method, a display automatic operation data generation program, and a computer-readable recording medium containing the display automatic operation data generation program, each generating display automatic operation data containing a change in parameter regarding a display operation in order to reproduce display intended by a generator.

According to one aspect of the present invention, a device for generating data to be displayed on a screen includes a display image data generation unit to generate display image data to be displayed with the use of inputted image data, an automatic operation data input unit to input automatic operation data previously prepared for operating the generation of the display image data, and a display image data generation operation processing unit to control the generation process in the display image data generation unit with the use of the automatic operation data inputted through the automatic operation data input unit.

Accordingly, when a generator who presents display image data to a user (person who views display image data) previously prepares desired automatic operation data, the display image data generation operation processing unit uses the automatic operation data inputted through the automatic operation data input unit to thereby control the generation process of the display image data in the display image data generation unit.

Therefore, it is possible to readily generate display image data intended by the generator and to present the display image data to the user.

Preferably, the automatic operation data contains data instructing the display image data generation unit to draw a line segment on a predetermined range in an image of the display image data.

Accordingly, at the time when an image based on the generated image data is displayed, a line segment or the like is drawn on a portion intended by the generator, so that the user can focus attention on such a portion. It is sufficient that the user pursues the reading of the portion designated by the line segment or the like.

Therefore, the user can pursue the reading of a document of an image along the drawn line segment. Thus, even when a viewpoint is moved largely, such as a change in a line, or display is switched discontinuously, the user never loses a portion to be read.

Preferably, the automatic operation data contains data instructing the display image data generation unit to extract, for the display image data, image data of a predetermined region in an image of the inputted image data.

Accordingly, it is possible to prepare such automatic operation data to thereby instruct to use, for display image data, image data of a predetermined region in an image of inputted image data.

Preferably, the automatic operation data contains data instructing to enlarge or reduce, at a predetermined magnification, an image of image data of the predetermined region to be extracted.

Accordingly, it is possible to prepare such automatic operation data to thereby instruct a magnification upon displaying an image extracted from an image of inputted image data.

Preferably, the display image data generation processing unit includes a partial image data generation processing unit to cut, from the inputted image data, data of a region designated on the basis of region designation data contained in the automatic operation data, to enlarge or reduce a size of the cut data on the basis of size data contained in the automatic operation data and to generate partial image data, and a whole image data generation processing unit to enlarge or reduce a size of the inputted image data on the basis of the size data and to generate whole image data, and the display image data is generated by composition of the whole image data and partial image data thus generated.

Accordingly, it is possible to prepare such automatic operation data to thereby collectively and automatically designate a region and a size of data cut from inputted image data, as for partial image data and whole image data cut from inputted image data and composed for generating display image data.

Preferably, the display image data thus generated additionally contains a line segment drawn on a range designated on the basis of range designation data contained in the automatic operation data.

Accordingly, it is possible to prepare such automatic operation data to thereby additionally contain a line segment drawn on a desired range in the generated display image data.

Preferably, the display image data thus generated additionally contains image data indicative of a position corresponding to the partial image data in the whole image data.

This additional image data has a position indicated by a frame.

Accordingly, it is possible to indicate a position corresponding to the partial image data in the whole image data in the generated display image data.

Preferably, the automatic operation data contains a set of a plurality of kinds of data, and the display image data generation operation processing unit selects, from the automatic operation data, a data set to be applied to the generation process on the basis of an operation by a user.

Accordingly, the user can optionally select an automatic operation data set to be applied for generation of display image data through a user's operation.

Preferably, the automatic operation data is contained in the inputted image data.

Accordingly, automatic operation data is not provided to a device separately from inputted image data, but is provided to the device in a state that it is contained in the inputted image data.

According to another aspect of the present invention, a method for generating data to be displayed on a screen includes a display image data generation step of generating display image data to be displayed with the use of inputted image data, an automatic operation data input step of inputting automatic operation data previously prepared for operating the generation of the display image data, and a display image data generation operation processing step of controlling the generation process in the display image data generation step with the use of the automatic operation data inputted in the automatic operation data input step.

According to still another aspect of the present invention, there is provided a display data generation program for allowing a computer to execute the aforementioned display data generation method.

According to yet another aspect of the present invention, there is provided a computer-readable recording medium containing a display data generation program for allowing a computer to execute the aforementioned display data generation method.

A display automatic operation data generation device according to yet another aspect of the present invention is a device for generating display automatic operation data recording therein a basic parameter set containing one or more basic parameters each referred to for operating generation of display image data from inputted image data, and has the following features.

The device includes an authoring control processing unit to determine respective values of the basic parameters of the basic parameter set and respective values of one or more control parameters of an authoring control parameter set in accordance with an external input, and an automatic operation data processing unit to control reading out of the basic parameter set from the display automatic operation data or writing of the determined values to the respective basic parameters of the basic parameter set of the display automatic operation data, in accordance with the values of the respective control parameters of the authoring control parameter set.

Accordingly, the authoring control processing unit controls an action using a basic parameter set as a parameter set referred to for generation of display image data to record the basic parameter set in display automatic operation data by the automatic operation data processing unit, with the use of an authoring control parameter set in accordance with an instruction inputted through an external device.

Further, the authoring control processing unit controls an action for reading out a parameter set used for generation of display image data from display automatic operation data, with the use of the authoring control parameter set in accordance with the instruction inputted through the external device.

Therefore, determination whether or not a basic parameter set having values determined in accordance with details inputted by a user through an external device must be recorded in display automatic operation data as a parameter set used by being read out for generation of display image data can be controlled by an authoring control parameter set having values determined in accordance with details inputted by the user through the external device. As a result, the user can readily prepare display automatic operation data only by an input for determining the values of the basic parameter set and those of the authoring control parameter set through the external device.

Further, the user can control an action for reading out the basic parameter set for generation of desired display image data from prepared display automatic operation data, by an input through an external device. As a result, the user can readily obtain display image data indicating a desired image.

Preferably, in the case where the display image data is partial image data of the inputted image data, the basic parameter set contains a basic parameter for designating the partial image data of the inputted image data.

Accordingly, the user can set, by an input through an external device, a basic parameter that designates a desired partial portion to be generated as display image data in inputted image data.

Preferably, in the case where the display image data is image data that whole image data of the inputted image data and partial image data of the inputted image data are overlapped with each other, the basic parameter set contains a basic parameter for designating a composition ratio of the overlap of the whole image data and the partial image data.

Accordingly, in the case where whole image data and partial image data in inputted image data are displayed so as to be overlapped with each other, the user can set a basic parameter for designating a composition ratio of the overlap, by an input through an external device.

Preferably, in the case where the display image data is image data for displaying an object in the corresponding display image, the basic parameter set contains a basic parameter for designating a display position of the object in the display image.

Accordingly, in the case of generating display image data that displays therein an object from inputted image data, the user can set a basic parameter for designating a display position of the object in the display image, by an input through an external device.

Preferably, the authoring control parameter set contains a writing presence/absence control parameter for instructing whether or not the determined value is written to each basic parameter of the basic parameter set of the automatic operation data.

Accordingly, the writing presence/absence control parameter having values determined in accordance with an input by the user through an external device can instruct whether or not the determined value is written to each basic parameter of a basic parameter set of display automatic operation data.

Preferably, the authoring control parameter set contains, among the one or more basic parameter sets already recorded in the display automatic operation data, the control parameter for instructing a target basic parameter set to be a target for reading out or writing by the automatic operation data processing unit, in the case where the writing presence/absence control parameter instructs that the determined value is not written, the automatic operation data processing unit reads out, from the automatic operation data, the basic parameter set instructed by the target basic parameter set, and respective values of the basic parameters of the basic parameter set read out by the automatic operation data processing unit are referred to in order to operate the generation of the display image data.

Preferably, when the plurality of basic parameter sets are already recorded in the display automatic operation data sequentially on a step basis, the control parameter for instructing the target basic parameter set is a movement instruction parameter for instructing a step positioned prior to or subsequent to the target basic parameter set of a current step to move to the basic parameter set, and in the case where the authoring control processing unit successively determines the same value specific times or more on the movement instruction parameter, the automatic operation data processing unit increases the number of moving steps per once.

Preferably, the display automatic operation data generation device further includes a macro display image data generation processing unit to generate macro display image data for specifying a position of the display image data in the whole image of the inputted image data.

According to yet another aspect of the present invention, a method for generating display automatic operation data recording therein a basic parameter set containing one or more basic parameters each referred to for operating generation of display image data from inputted image data includes an authoring control processing step of determining respective values of basic parameters of the basic parameter set and respective values of one or more control parameters of an authoring control parameter set in accordance with an external input, and an automatic operation data processing step of controlling reading out of the basic parameter set from the display automatic operation data or writing of the determined values to the respective basic parameters of the basic parameter set of the display automatic operation data, in accordance with the values of the respective control parameters of the authoring control parameter set.

According to yet another aspect of the present invention, there is provided a display automatic operation data generation program for allowing a computer to execute the aforementioned display automatic operation data generation method.

According to yet another aspect of the present invention, there is provided a computer-readable recording medium containing the aforementioned automatic operation data generation program.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an image display data generation device according to a first embodiment.

FIG. 2 shows a configuration of a computer on which an image display data generation device according to each embodiment is mounted.

FIG. 3 is a flowchart showing processes in the image display data generation device according to the first embodiment.

FIG. 4 shows one example of whole image data.

FIG. 5 shows one example of partial image data.

FIG. 6 shows a state where whole image data and partial image data are displayed concurrently.

FIG. 7 shows a state where whole image data and partial image data are displayed concurrently and frames are added.

FIG. 8 shows a state where a frame is added to whole image data.

FIG. 9 shows a state where frames are added to partial image data.

FIG. 10 shows a state where a straight line is drawn on a displayed image.

FIG. 11 shows a state where straight lines are drawn on a displayed image.

FIG. 12 shows a configuration of an image display data generation device according to a second embodiment.

FIG. 13 is a flowchart showing processes in the image display data generation device according to the second embodiment.

FIG. 14 shows a configuration of an image automatic display device according to a third embodiment.

FIG. 15 is a flowchart showing processes in the image automatic display device according to the third embodiment.

FIG. 16 shows automatic operation data according to the third embodiment.

FIG. 17 shows a configuration of an image automatic display device according to a fourth embodiment.

FIG. 18 shows automatic operation data according to the fourth embodiment.

FIG. 19 shows a configuration of a display automatic operation data generation device according to a fifth embodiment.

FIG. 20 is a flowchart showing processes in the display automatic operation data generation device according to the fifth embodiment.

FIG. 21 shows one example of automatic operation data according to the fifth embodiment.

FIG. 22 shows an action example of the display automatic operation data generation device according to the fifth embodiment.

FIG. 23 shows an action example of the display automatic operation data generation device according to the fifth embodiment.

FIG. 24 shows a configuration of a display automatic operation data generation device according to a sixth embodiment.

FIG. 25 is a flowchart showing processes in the display automatic operation data generation device according to the sixth embodiment.

FIG. 26 shows one example of an image according to the first embodiment.

### DESCRIPTION OF THE PREFERRED EMBODIMENTS

Hereinafter, description will be given of embodiments of the present invention with reference to the drawings.

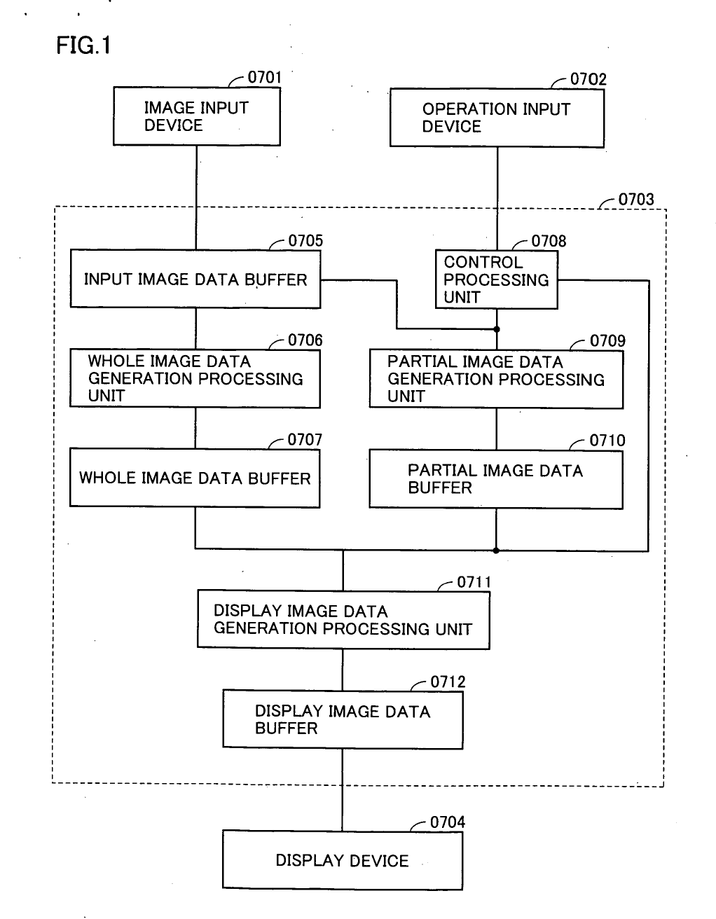

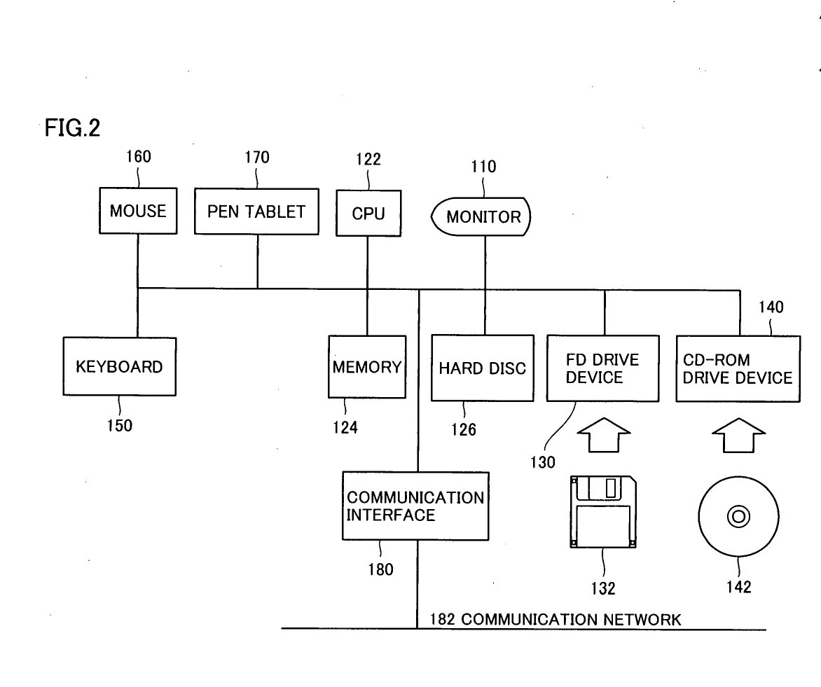

FIG. 1 shows a configuration of an image display data generation device according to a first embodiment. FIG. 2 shows a configuration of a computer applied to each embodiment of the present invention. The computer can be equipped with each of the image display data generation device according to the first embodiment and an image display data generation device according to a second embodiment to be described later. The computer can be also equipped with each of an image automatic display device according to a third embodiment and an image automatic display device according to a fourth embodiment to be described later.

With reference to FIG. 2, the computer includes a monitor 110 formed from a CRT (Cathode Ray Tube), liquid crystal or the like, a CPU (Central Processing Unit) 122 for collectively controlling the computer itself, a memory 124 configured by including a ROM (Read Only Memory) or a RAM (Random Access Memory), a hard disc 126, an FD drive device 130 having an FD (Flexible Disc) 132 inserted thereinto in a removable manner to thereby access inserted FD 132, a CD-ROM (Compact Disc Read Only Memory) drive device 140 having a CD-ROM 142 inserted thereinto in a removable manner to thereby access inserted CD-ROM 142, a keyboard 150, a mouse 160, a pen tablet 170, and a communication interface 180 for communicating and connecting the computer with and to various communication networks 182 including the Internet and the like. These components are communicated with and connected to each other via a bus.

The computer may be provided with a magnetic tape device having a magnetic tape in form of a cassette inserted thereinto in a removable manner to thereby access the magnetic tape.

With reference to FIG. 1, a display image data generation device 0703 receives inputted image data through an image input device 0701 connected thereto and user operation information through an operation input device 0702 connected thereto, and generates display image data to output it to a display device 0704 connected thereto. Image input device 0701 is connected to the computer shown in FIG. 2. Herein, image input device 0701 is connected to the computer via communication interface 180. Operation input device 0702 corresponds to keyboard 150, mouse 160 or pen tablet 170 shown in FIG. 2 or a joint pad (not shown). Display device 0704 corresponds to monitor 110 shown in FIG. 2.

### First Embodiment

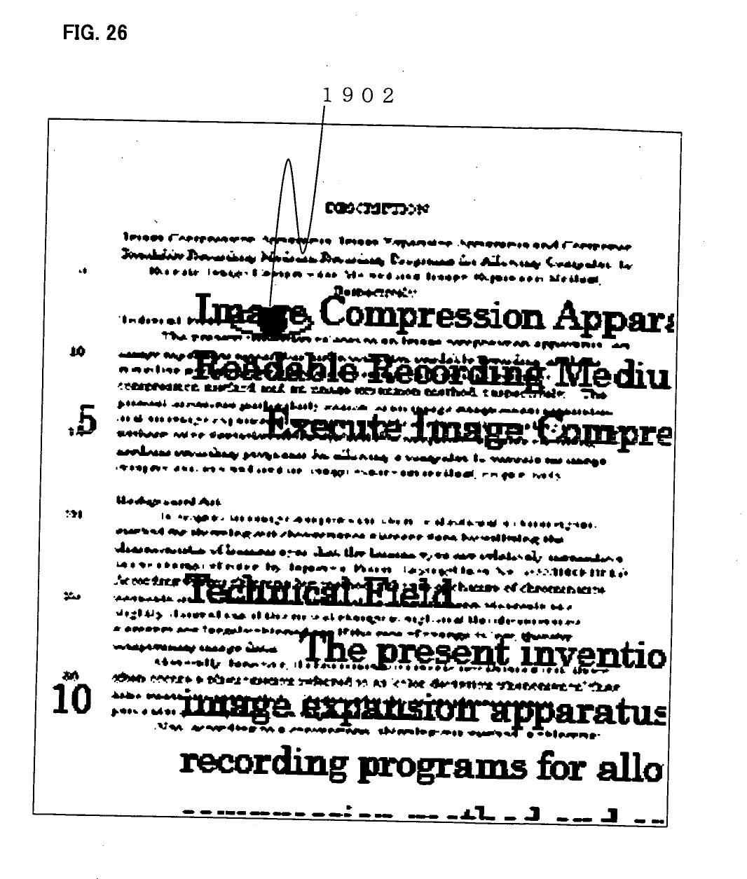

A first embodiment describes an image display data generation device having the function of allowing a user to manually designate display levels of whole image data and partial image data and, also, drawing an underline on an optional portion of an image. Herein, a line segment to be drawn is a straight line; however, the present invention is not limited to thereto. Examples of the line segment include a solid line, a dotted line, a wavy line and the like. Also herein, the line segment is not specified in its color, thickness and the like. These attributes may be alterable. As shown in FIG. 26, in place of a line, any form capable of indicating a position may be adopted, such as optional graphics and an illustration 1902.

Image display data generation device 0703 includes an input image data buffer 0705, a whole image data generation processing unit 0706, a whole image data buffer 0707, a control processing unit 0708, a partial image data generation processing unit 0709, a partial image data buffer 0710, a display image data generation processing unit 0711 and a display image data buffer 0712.

Input image data buffer 0705 stores image data inputted through image input device 0701. Whole image data generation processing unit 0706 reads an inputted image from input image data buffer 0705 and outputs whole image data. Whole image data buffer 0707 stores the whole image data outputted from whole image data generation processing unit 0706. Control processing unit 0708 controls generation of display image data in accordance with information inputted through operation input device 0702. Partial image data generation processing unit 0709 reads the inputted image data from input image data buffer 0705, and generates partial image data to be outputted. Partial image data buffer 0710 stores the partial image data outputted from the partial image data generation processing unit 0709.

Display image data generation processing unit 0711 reads out the whole image data from whole image data buffer 0707 and the partial image data from partial image data buffer 0710, respectively, subjects the image data thus read out to processing in accordance with control information from control processing unit 0708, and generates display image data to be outputted. Display image data buffer 0712 stores the display image data outputted from display image data generation processing unit 0711.

Input image data buffer 0705, whole image data buffer 0707, partial image data buffer 0710 and display image data buffer 0712 are realized by RAMs such as a flash memory not shown in FIG. 2, memory 124 and hard disc 126. Whole image data generation processing unit 0706, control processing unit 0708, partial image data generation processing unit 0709 and display image data generation processing unit 0711 may be realized by virtual circuits or by virtual circuitry realized by arithmetic processing circuits (not shown) of CPU 122 of the computer shown in FIG. 2, that is, a program executed by CPU 122.

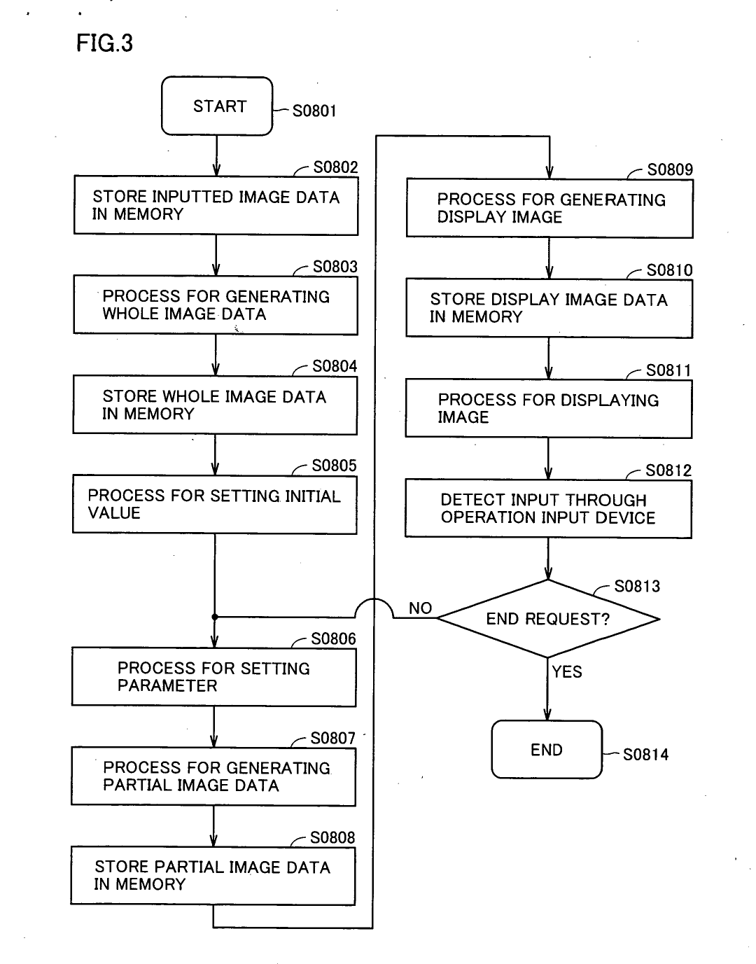

FIG. 3 shows a flow of processes in image display data generation device 0703 according to the first embodiment. Herein, an inputted image corresponding to inputted image data has a lateral size XSIZE and a longitudinal size YSIZE. Display device 0704 has a lateral display size XDISPLAYSIZE and a longitudinal display size YDISPLAYSIZE.

Upon start of an action, inputted image data received from image input device 0701 is stored in input image data buffer 0705 (S0801, S0802).

Whole image data generation processing unit 0706 receives the inputted image data from input image data buffer 0705, enlarges or reduces a size of the inputted image data to (XDISPLAYSIZE/XSIZE) in the lateral direction×(YDISPLAYSIZE/YSIZE) in the longitudinal direction in such a manner that the inputted image data has the same size as the display size, and outputs enlarged or reduced image data as whole image data (S0803).

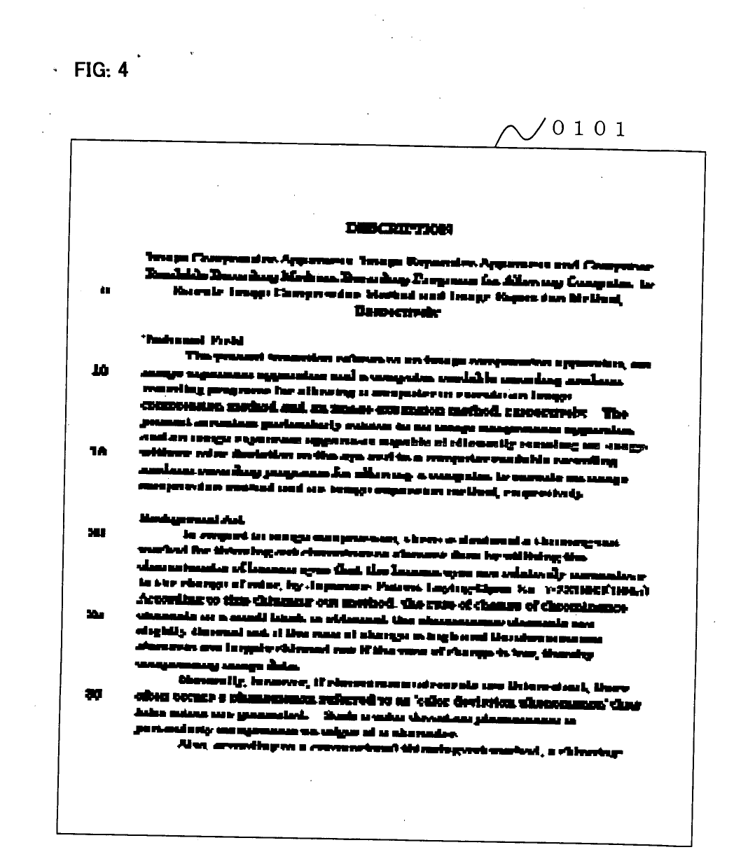

In the enlargement/reduction process, linear interpolation is used; however, the present invention is not limited to the linear interpolation. FIG. 4 shows an example of whole image data 0101.

The whole image data outputted from whole image data generation processing unit 0706 is stored in whole image data buffer 0707 (S0804).

Control processing unit 0708 sets initial values of various variables (parameters) and the like for the processes (S0805). Herein, description will be given of the various variables. Control processing unit 0708 manages variables regarding only the whole image data, variables regarding only the partial image data and variables regarding both the whole image data and the partial image data.

As for only the whole image data, control processing unit 0708 manages a whole image straight line presence/absence whole_line indicative of presence/absence of a straight line in the whole image. Whole image straight line presence/absence whole_line has a value of 1 in the case of the presence of the straight line and a value of 0 in the case of the absence of the straight line.

As for only the partial image data, control processing unit 0708 manages the following variables: positions (xposition, yposition) in an image of inputted image data on a left upper point of an image of the partial image data, a display magnification arate, and a partial image straight line presence/absence part_line indicative of presence/absence of a straight line in a partial image. Partial image straight line presence/absence part_line has a value of 1 in the case of the presence of the straight line and a value of 0 in the case of the absence of the straight line. Positions (xposition, yposition) are a variable for determining that which portion of the inputted image data is used as the partial image data.

As for both the whole image data and the partial image data, control processing unit 0708 manages straight line start points (xstart, ystart), straight line end points (xend, yend), and a composition ratio orate indicative of a ratio of the sum of the partial image data and the whole image data. Straight line start points (xstart, ystart) and straight line end points (xend, yend) indicate positions in the image of the inputted image data.

Whole image straight line presence/absence whole_line and partial image straight line presence/absence part_line use the values 1 and 0 as a reference of the presence/absence of the straight line. The present invention is not limited thereto and any values used as a reference of presence/absence may be used.

Control processing unit 0708 sets data of an image corresponding to a left upper portion of the image of the inputted image data as partial image data, for example, (xposition, yposition)=(0, 0). As respective initial values, control processing unit 0708 sets display magnification arate at 1 (the display magnification of the partial image data is equal to that of the inputted image data), the composition ratio orate at 0.8, and partial image straight line presence/absence part_line and whole image straight line presence/absence whole_line at 0 (the absence of the straight line), respectively. These setting values are illustrative and any other values may be adopted.

The aforementioned parameters specified for the partial image data are not limited to positions (xposition, yposition) and display magnification arate of the inputted image data on the left upper point of the partial image data. It is sufficient that the positional relation and the size of the inputted image of the partial image are laid down. For example, in place of display magnification arate, positions on a right lower point of the inputted image data of the partial image data may be used.

Normally, control processing unit 0708 acts upon reception of the information inputted by the user through operation input device 0702. Herein, the initial values are set in place of the inputted information by the user.

Control processing unit 0708 receives the input through operation input device 0702 to alter (set) the values of the various variables on the basis of details of the input (S0806).

Partial image data generation processing unit 0709 receives the inputted image data from input image data buffer 0705, subjects the inputted image data thus received to processing with the use of the information (including the parameter values) designated by control processing unit 0708, and generates partial image data to be outputted (S0807).

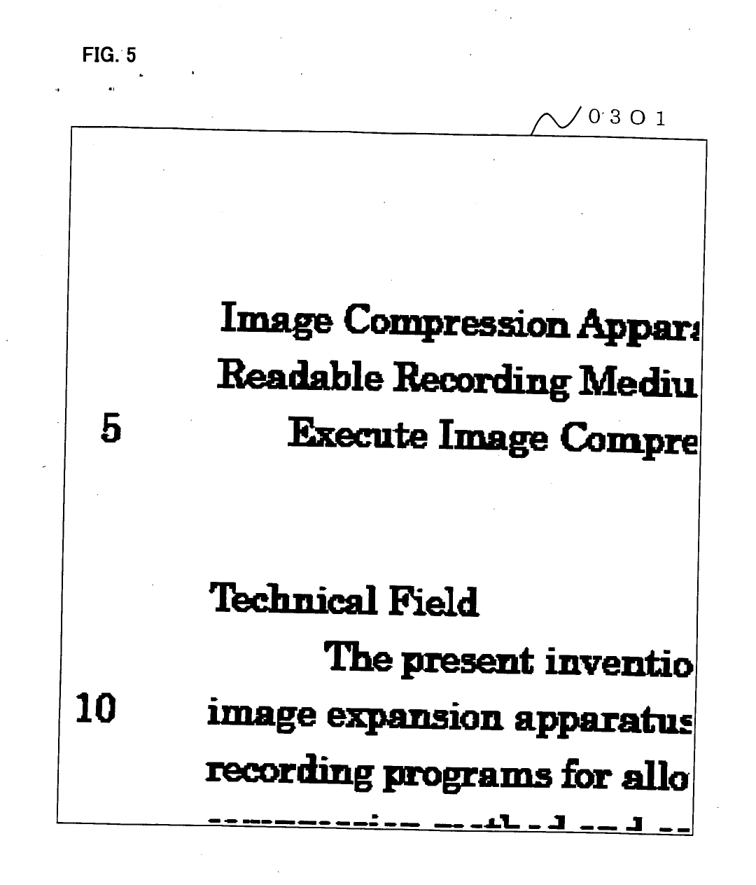

In the partial image data generation process, an image having a size of (XDISPLAYSIZE/arate) in the lateral direction×(YDISPLAYSIZE/arate) in the longitudinal direction is extracted from positions (xposition, yposition) of the image of the inputted image data, the extracted image is enlarged or reduced at display magnification arate, and the enlarged or reduced image is used as the partial image data. Herein, linear interpolation is used in the enlargement/reduction process; however, any other enlargement/reduction technique may be used. FIG. 5 shows an example of partial image data 0301.

The partial image data outputted from partial image data generation processing unit 0709 is stored in partial image data buffer 0710 (S0808).

Display image data generation processing unit 0711 reads out the whole image data from whole image data buffer 0707 and the partial image data from partial image data buffer 0710, respectively, subjects the image data thus read out to processing with the use of the information (including the various parameter values) designated by control processing unit 0708, and generates display image data to be outputted (S0809).

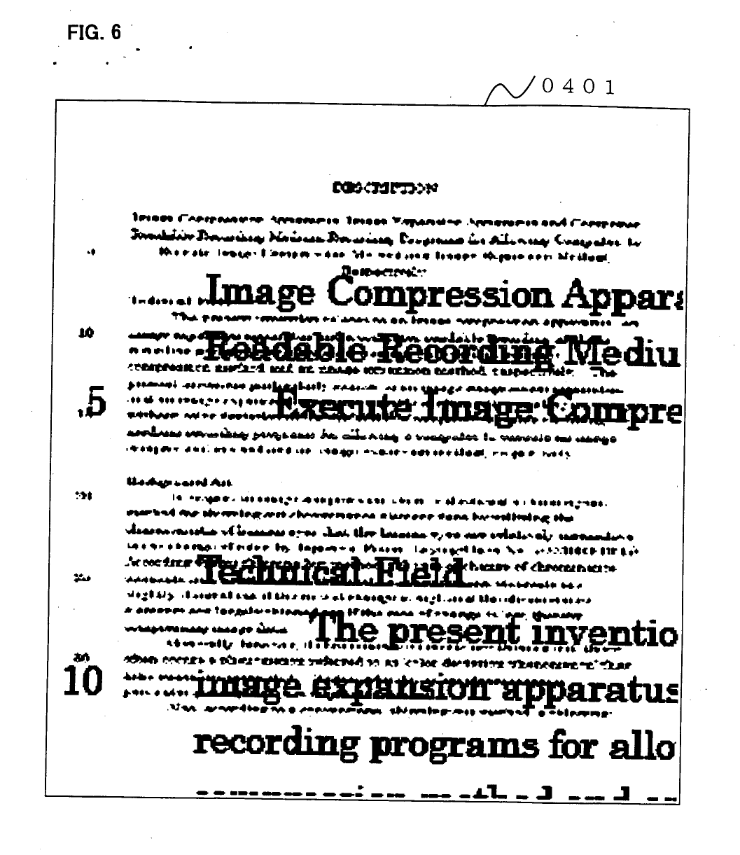

The display image data is generated so as to satisfy the following equation: value3(x, y)=orate×value2(x, y)+(1−orate)×value1(x, y), wherein value1(x, y) represents a pixel value of the whole image data in a coordinate (x, y), value2(x, y) represents a pixel value of the partial image data in the coordinate (x, y) and value3(x, y) represents a pixel value of the display image data in the coordinate (x, y) (FIG. 6 shows display image data 0401 in this stage). Then, data of a frame is added to the display image data. The frame is used for specifying a position in an entire display region of display device 0704 corresponding to the position of the partial image data in the whole image data.

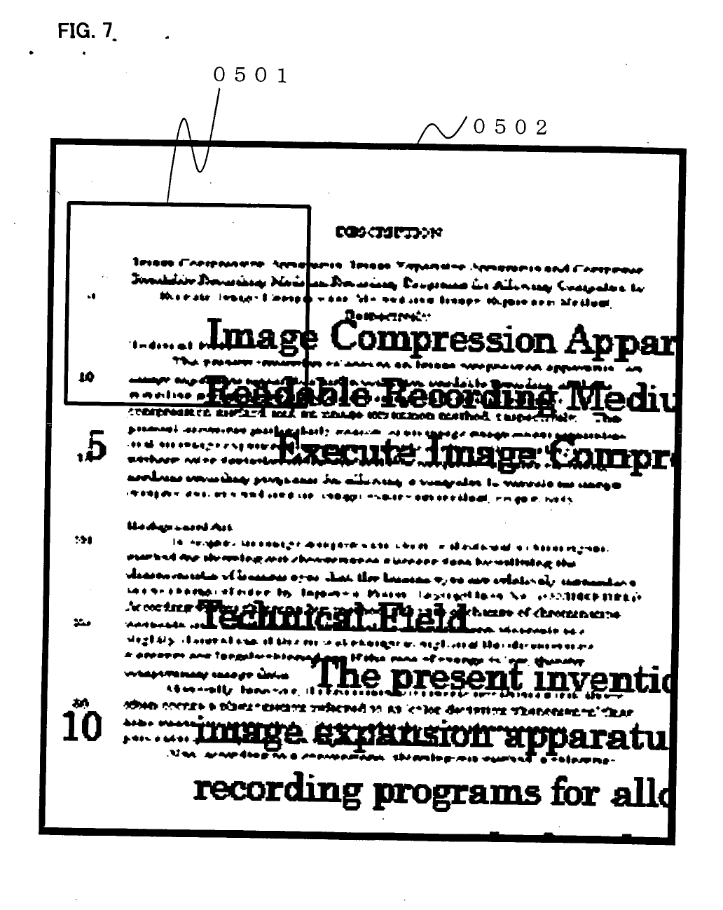

If composition ratio orate is larger than 0 and smaller than 1, as for the display image data, the whole image data and the partial image data are concurrently displayed as an image shown in FIG. 7, for example. A frame 0501 shown in FIG. 7 corresponds to the aforementioned frame for indicating the position of the partial image data in the whole image data. In order to further clarify the relation between the whole image data and the partial image data, an outer frame is added like a frame 0502 for the display image data. The outer frame may be used as a frame of the partial image data corresponding to frame 0501 of the whole image data. Alternatively, the corresponding frame may not be added as shown in FIG. 6.

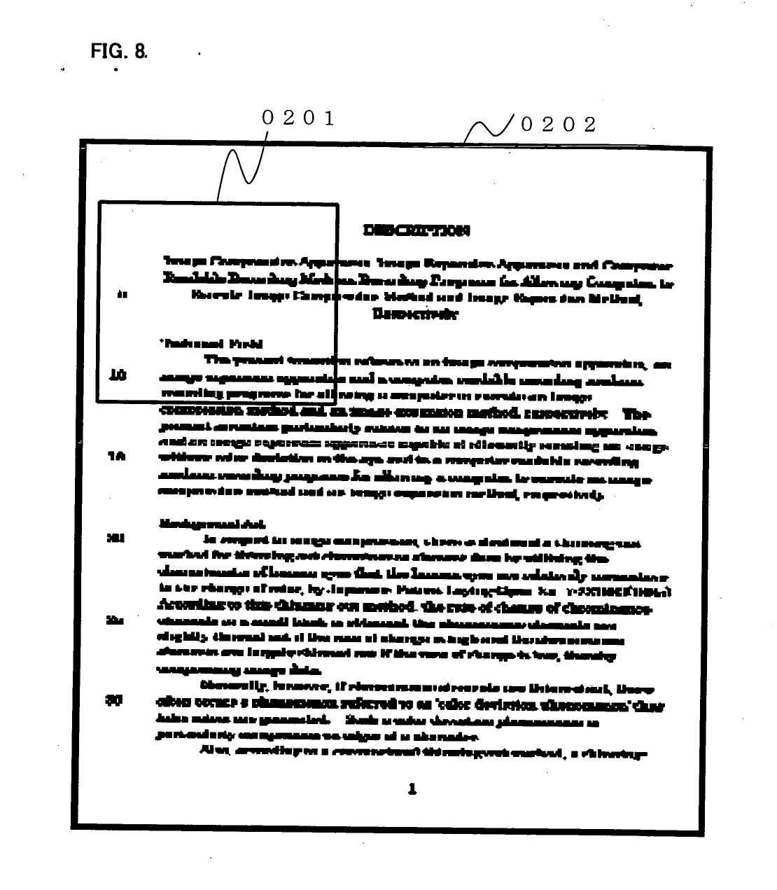

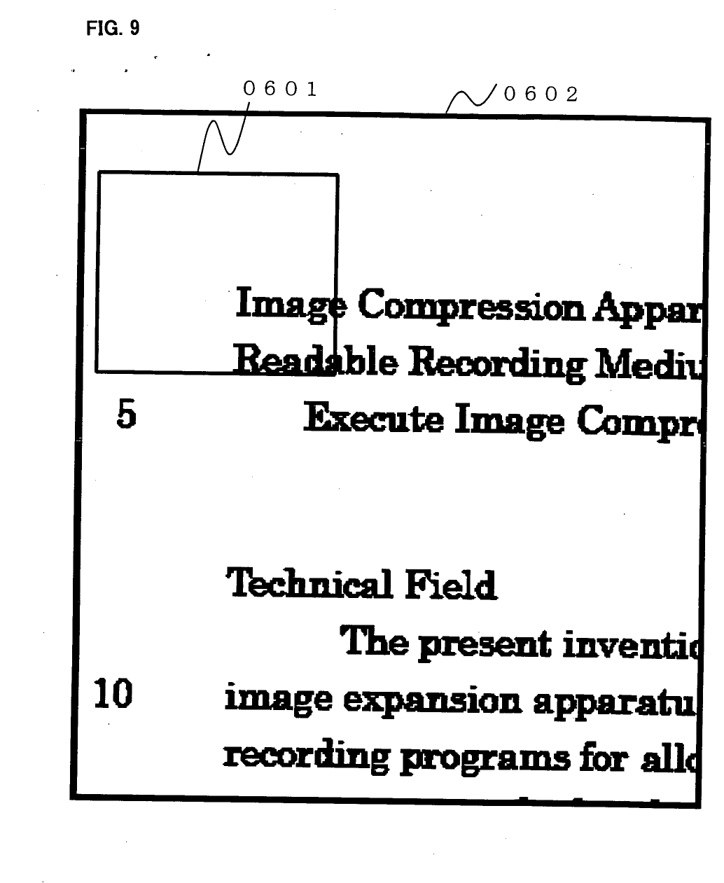

If composition ratio orate is 0, as for the display image data, whole image data 0202 including frame 0201 of the partial image data is displayed as shown in FIG. 8, for example. If composition ratio orate is 1, as for the display image data, partial image data having frames 0601 and 0602 is displayed as shown in FIG. 9, for example.

If composition ratio orate has a limited range, setting can be made in such a manner that the whole image data and the partial image data are displayed at all times.

Frames 0501, 0201 and 0601 shown in FIGS. 7, 8 and 9 are each a rectangle positioned at a left upper point (xposition×XDISPLAYSIZE/XSIZE, yposition×YDISPLAYSIZE/YSIZE) and a right lower point ((xposition+XDISPLAYSIZE/arate)×XDISPLAYSIZE/XSIZE, (yposition+YDISPLAYSIZE/arate)×YDISPLAYSIZE/XSIZE).

When information (variable) instructing whether the frame information of the partial image data is added to the display image data is added to a variable group managed by control processing unit 0708, the user can dynamically designate the presence/absence of display of the frame.

If whole image straight line presence/absence whole_line is 1, data of a straight line connecting between two points (xstart×XDISPLAYSIZE/XSIZE, ystart×YDISPLAYSIZE/YSIZE) and (xend×XDISPLAYSIZE/XSIZE, yend×YDISPLAYSIZE/YSIZE) is added to the whole image data.

If partial image straight line presence/absence part_line is 1, data of a straight line connecting between two points (((xstart−xposition)×arate, (ystart−yposition)×arate), ((xend−xposition)×arate, (yend−yposition)×arate)) is added to the partial image data.

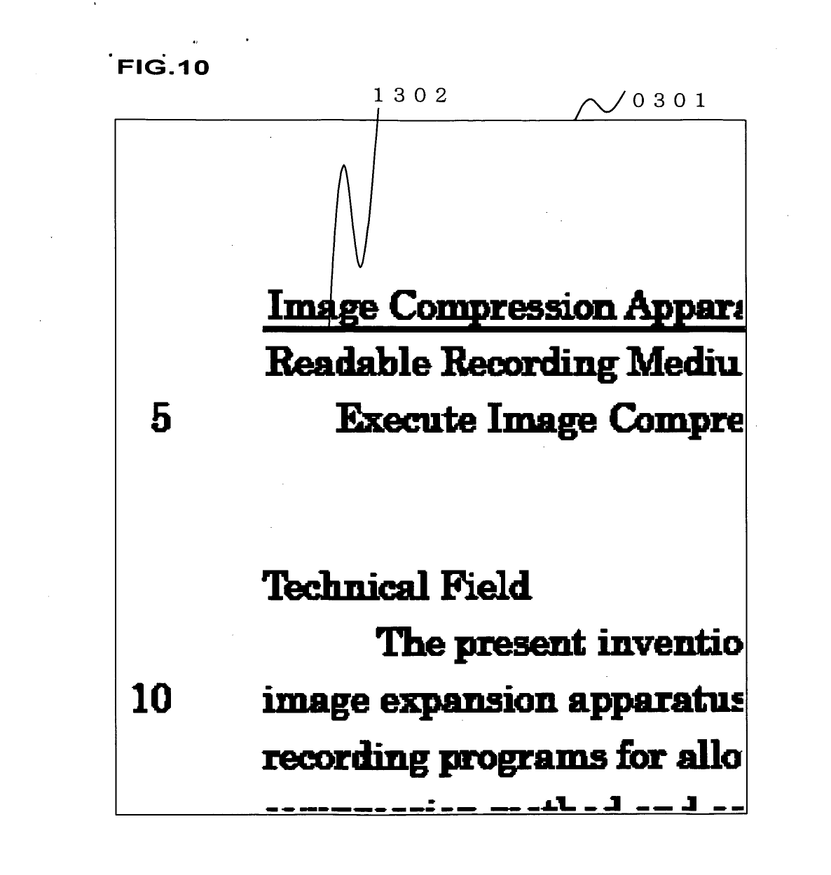

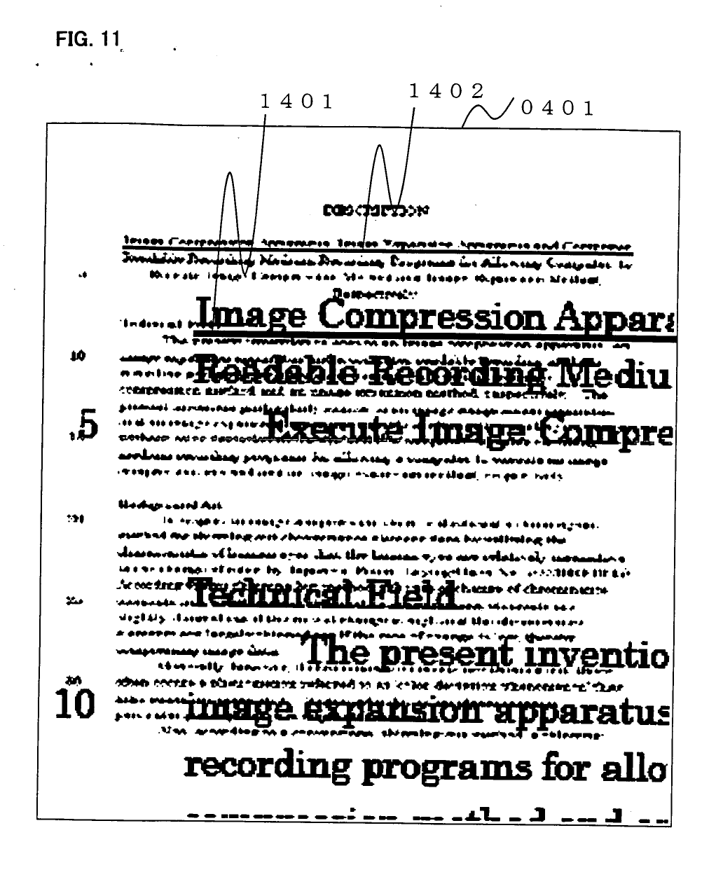

A straight line designated by parameters xstart, ystart, xend and yend is used for indicating a portion of an image or a line of a document where a user must pay attention, like modes shown in FIGS. 10 and 11. FIG. 10 shows a state where a straight line 1302 is drawn on partial image data 0301 shown in FIG. 5. FIG. 11 shows a state where a straight line 1401 is drawn on the whole image and a straight line 1402 is drawn on the partial image in image 0401 shown in FIG. 6. Such a straight line serves as a guide for the viewpoint of the user in the displayed image. The straight line may be used for designating a partial image corresponding to important information in the displayed image.

The display image data generated by display image data generation processing unit 0711 is stored in display image data buffer 0712 (S0810), and an image of the display image data stored in display image data buffer 0712 is outputted to display device 0704 (S0811).

Thereafter, control processing unit 0708 detects the input through operation input device 0702 (S0812). If the input through operation input device 0702 is an end request, an end process is performed. If not, the processes subsequent to step S0806 are performed again (S0813, S0814).

According to this embodiment, when the whole image data and the partial image data are displayed in an overlapped manner as shown in FIG. 6 or 7, densities in display of the image data are different from each other on the basis of the value of composition ratio orate. Therefore, a user can distinguish an image such as a character displayed by the whole image data from that displayed by the partial image data to thereby visually recognize each image. Frames 0502 and 0501 indicating the positional relation between the partial image data and the whole image data are displayed as shown in FIG. 7. Thus, the user can read a document while grasping a position of partial image data and an entire layout of the document even when the size of a character of whole image data is small.

### Second Embodiment

In a second embodiment, there is provided a function of automatically controlling composition ratio orate which is the densities in image display of whole image data and partial image data.

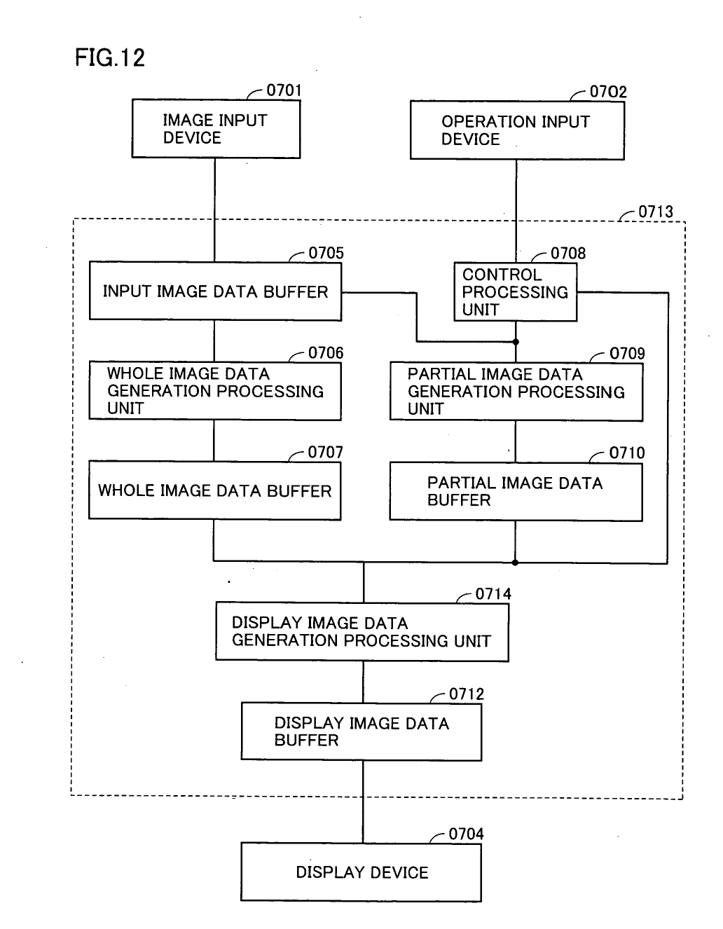

FIG. 12 shows a configuration of an image display data generation device 0713 according to the second embodiment. Image display data generation device 0713 is different from image display data generation device 0703 shown in FIG. 1 in the following point. That is, image display data generation device 0713 includes a display image data generation processing unit 0714 in place of display image data generation processing unit 0711. The other components of image display data generation device 0713 are similar to those shown in FIG. 1; therefore, specific description thereof will not be given here.

In image display data generation device 0713, the various variables for the processes described in the first embodiment are previously set (for example, initial value setting or setting through a user's operation), except composition ratio orate. Display image data generation processing unit 0714 calculates composition ratio orate on the basis of image data to be displayed.

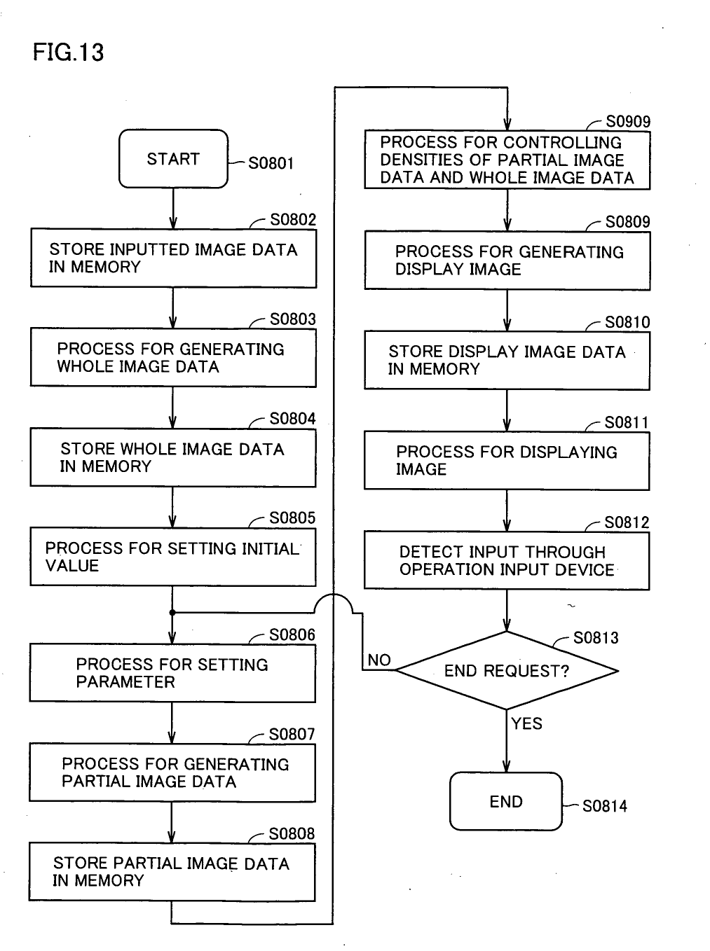

FIG. 13 shows a flow of processes in image display data generation device 0713 according to the second embodiment. The flow of the processes shown in FIG. 13 is different from that shown in FIG. 3 in the first embodiment in the following point. That is, in the flow of the processes shown in FIG. 13, a density control process S0909 for controlling a density at the time when whole image data and partial image data are displayed in an overlapped manner is additionally provided between process S0808 and process S0809. The other processes shown in FIG. 13 are similar to those shown in FIG. 3; therefore, specific description thereof will not be given here.

In an action, processes S0801 to S0808 are carried out as described above. Then, in the density control process, display image data generation processing unit 0714 reads out partial image data from partial image data buffer 0710, and determines composition ratio orate between the partial image data thus read out and whole image data (S0909).

More specifically, composition ratio orate between the partial image data and the whole image data is determined on the basis of importance of the partial image data, that is, the level of importance of information and details indicated by the partial image data. For example, if the importance of the partial image data is high, composition ratio orate becomes high. In contrast, if the importance of the partial image data is low, composition ratio orate becomes low. Alternatively, composition ratio orate may be determined on the basis of the level of importance of one data with respect to the other data between the partial image data and the whole image data. If the importance of the partial image data is high, composition ratio orate is made higher and a composition process that places importance on the partial image data is carried out. In contrast, if the importance of the whole image data is high, composition ratio orate is made lower and a composition process that places importance on the whole image data is carried out.

As a result, if the partial image data is important, an image based on the whole image data becomes light-colored, and an image based on the partial image data becomes high-colored and is displayed clearly. In contrast, if the partial image data is not important, the image based on the partial image data becomes light-colored and the image based on the whole image data becomes high-colored and is displayed clearly.

Composition ratio orate is computed with the use of a sum SUM of pixel values of the partial image data in accordance with the following equation: orate=1−SUM/(255×XDISPLAYSIZE×YDISPLAYSIZE). The pixel value refers to a value indicative of a brightness component of an image.

This computation is one example and, therefore, the present invention is not limited thereto. Composition ratio orate may be computed with the use of, as a count number N, a result of counting of pixels having a pixel value corresponding with a threshold value TH or less of the partial image data in accordance with the following equation: orate=N/(XDISPLAYSIZE×YDISPLAYSIZE).

Composition ratio orate is computed on assumption that the background of inputted image data is white. However, the computation can be carried out with optional background color by using, as variable SUM, the sum of difference with the background color. In addition, composition ratio orate may be determined on the basis of the magnitude of root square mean error (distance) with the background color.

Also in the case of using count number N which is a result of counting of the pixels having the pixel value corresponding with threshold value TH or less, the computation can be carried out with an optional background color by using count number N upon setting threshold value TH by the difference with the background color.

Using the number of edges indicated based on the partial image data as a reference, if the number of edges is large, composition ratio orate may be made larger and if the number of edges is small, composition ratio orate may be made smaller. This shows that an image with a large number of edges is abound in change and is complicated. Therefore, such an image is high-colored and is displayed clearly even when the image is complicated. Such an edge may be detected with the use of, for example, a Sobel filter.

Further, using the number of characters of the partial image data as a reference, if the number of characters is large, composition ratio orate may be made larger and if the number of characters is small, composition ratio orate may be made smaller. This shows that in an image with a large number of characters, the characters are displayed at narrow intervals and the size thereof is relatively small. However, such a character is high-colored; therefore, the user can clearly read the small characters. Such a character may be detected using a technique disclosed in, for example, Japanese Patent Laying-Open No.2002-298139. In this technique, image data is inputted, and a region of a character in an image is determined on the basis of a characteristic amount of the inputted image data.

Thereafter, processes S0809 to S0814 are carried out similarly to those shown in FIG. 3.

According to this embodiment, image display data generation device 0713 has the function of dynamically adjusting composition ratio orate between the whole image data and the partial image data. Therefore, if the partial image data is important, an image based on the whole image data indicating a layout becomes light-colored. In contrast, if the partial image data is not important, the image based on the whole image data indicating the layout becomes high-colored. Thus, in the overlapped portion of the whole image data and the partial image data, an image indicating important information can be preferentially displayed to be high-colored; therefore, it is possible to avoid the important information from being difficult to read.

The aforementioned processes in the image display data generation device according to this embodiment may be carried out by a server and a client through communication. For example, input image data buffer 0705, whole image data generation processing unit 0706, control processing unit 0708 and partial image data generation processing unit 0709 are realized on the server side and whole image data buffer 0707, partial image data buffer 0710, display image data generation processing unit 0711 and display image data buffer 0712 are realized on the client side, so that the whole image data and partial image data with small data amount can be viewed through communication. Therefore, such data can be suitably viewed in comparison with a method for downloading inputted image data as it is.

### Third Embodiment

A third embodiment describes an image automatic display device in a case where a user's operation is partly automated with the use of automatic operation data (to be described later). The image automatic display device according to the third embodiment has therein display image data generation device 0703 according to the first embodiment which is used as a display image data generation processing engine.

Herein, the display image data generation device according to the first embodiment is used as display image data generation device 0703. However, any other devices may be used as long as they have the function of generating image data to be displayed on the display device. Such a device can be readily applied by determining a set of automatic operation data (to be described later) in accordance with variables operable from outside the device.

In the automatic operation data, procedures for inputting values of the various variables to control processing unit 0708 of display image data generation device 0703 which is the display image data generation processing engine are described previously. The image automatic display device according to the third embodiment can be acted by a series of procedures in accordance with the automatic operation data, thereby sequentially displaying image data previously determined by the respective procedures. The user can perform an advancement operation for advancing the input procedures in a forward direction and a retreat operation for returning the procedures, thereby selecting the procedures and displaying an image in accordance with the selected procedures.

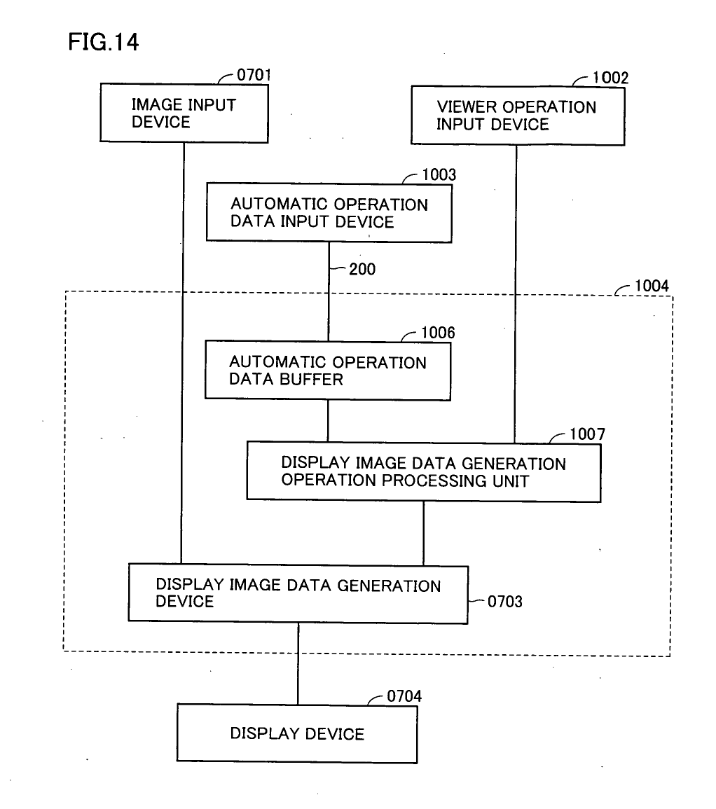

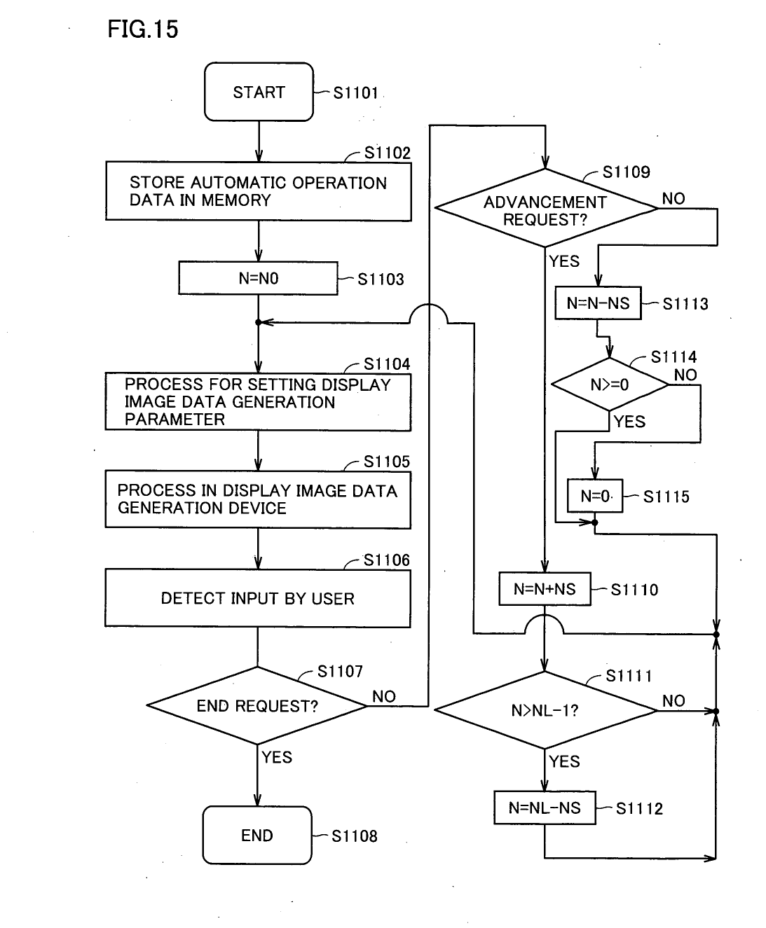

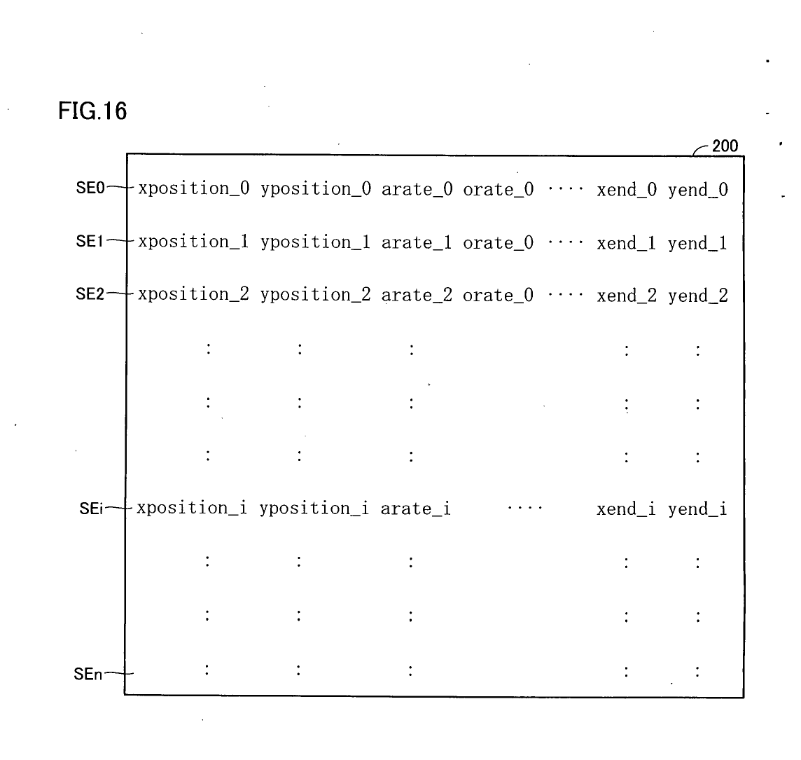

FIG. 14 shows a configuration of an image automatic display device 1004 according to the third embodiment. FIG. 15 is a flowchart showing a flow of processes in the image automatic display device according to the third embodiment. FIG. 16 shows one example of automatic operation data 200 according to the third embodiment.

Image automatic display device 1004 shown in FIG. 14 connects among image input device 0701, a viewer operation input device 1002, an automatic operation data input device 1003 and display device 0704. Image automatic display device 1004 receives inputted image data, automatic operation data 200 and user operation information from image input device 0701, automatic operation data input device 1003 and viewer operation input device 1002, respectively, and outputs (displays) a result of processing based on the information thus received to (on) display device 0704.

Image automatic display device 1004 includes an automatic operation data buffer 1006, a display image data generation processing unit 1007 and display image data generation device 0703. Automatic operation data buffer 1006 stores automatic operation data 200 inputted through automatic operation data input device 1003.

Display image data generation operation processing unit 1007 receives automatic operation data 200 read out from automatic operation data buffer 1006 and the user operation information given from viewer operation input device 1002, and generates values of various variables (parameters) for controlling display image data generation device 0703 to thereby output the generated values to display image data generation device 0703.

Display image data generation device 0703 has the configuration similar to that shown in FIG. 1; therefore, specific description thereof will not be given here. In an action, display image data generation device 0703 receives the image data inputted through image input device 0701 via input image data buffer 0705, and control processing unit 0708 receives the values of the various variables outputted from display image data generation operation processing unit 1007. On the basis of the information thus received, whole image data generation processing unit 0706 and partial image data generation processing unit 0709 generate whole image data and partial image data, respectively. Thereafter, display image data generation processing unit 0711 generates image data to be displayed, on the basis of the whole image data, the partial image data and the values of the various variables thus received. The generated image data is given to display device 0704 via display image data buffer 0712 and is displayed on display device 0704.

Automatic operation data buffer 1006 is realized by a flash memory as memory 124 or a RAM such as hard disc 126. For example, display image data generation operation processing unit 1007 may be realized by individual circuits or may be realized by virtual circuitry (program process) realized by arithmetic processing circuits of CPU 122 of the computer shown in FIG. 2.

Automatic operation data 200 is similar to that inputted to control processing unit 0708 of display image data generation device 0703 according to the first embodiment. With reference to FIG. 16, automatic operation data 200 is prepared as a kind of file in which a plurality of sets SEi (i=0, 1, 2, . . . , n) are registered. Each set SEi includes the variables of positions xposition, yposition of the inputted image data on the left upper point of the partial image data, display magnification arate of the partial image data, composition ratio orate between the partial image data and the whole image data, and straight line drawn portions xstart, ystart, xend, yend. The definition of each variable of set SEi is equal to that described in the first embodiment.

On the basis of the value of each variable included in one set SEi, a display image state is determined uniquely. It is assumed herein that sets SE0, SE1, SE2, . . . are sequentially registered from the head of the file of automatic operation data 200. Set SEi used for generating the displayed image data currently is referred to as current set SEi.

In automatic operation data 200, as shown in FIG. 16, each variable value in set SEi is delimited with single spaces and a line break is inserted between sets SEi.

The data structure of automatic operation data 200 is not limited to that shown in FIG. 16. It is sufficient that automatic operation data 200 has a structure capable of reading out each variable value of each set SEi.

Description will be given of an action of image automatic display device 1004 using automatic operation data 200 shown in FIG. 16 in accordance with the flowchart shown in FIG. 15. In order to carry out the processes shown in FIG. 15, there are prepared a variable NL indicating the total number of sets SEi registered in automatic operation data 200, a variable NS indicating an interval for reading out set SEi from automatic operation data 200, and a variable N indicating the order of the current set in automatic operation data 200. It is assumed herein that variable NS is preset at 1.

When variable NS is 1, sets SEi can be sequentially read out one by one from automatic operation data 200. Every time the user issues an instruction of an advancement operation or a retreat operation through viewer operation input device 1002, variable Ns acts to determine which set SEi prior to or subsequent to current set SEi is read out from automatic operation data 200. For example, if the current set is set SE5 and variable NS is 1, it is possible to determine set SEi to be read out sequentially from SE6, SE7, SE8, . . . every time the advancement operation is carried out and from SE4, SE3, SE2, . . . every time the retreat operation is carried out. For example, if variable NS is 2, it is possible to determine set SEi read out while skipping set SEi one by one from SE7, SE9, SE11, . . . every time the advancement operation is carried out and from SE3, SE1, . . . every time the retreat operation is carried out.

When the processing starts in image automatic display device 1004 (S101), image automatic display device 1004 receives automatic operation data 200 from automatic operation data input device 1003 to store it in automatic operation data buffer 1006 (S1102). Then, variable N is set at an initial value NO (S1103).

Display image data generation operation processing unit 1007 reads out values of respective variables xposition_i, yposition_i, arate_i, orate i, part_line_i, whole_line_i, xstart_i, ystart_i, xend_i and yend_i of set SEi instructed by variable N of i from automatic operation data 200 in automatic operation data buffer 1006, and sets variables xposition, yposition, arate, orate, part_line, whole_line, xstart, ystart, xend and yend for the respective processes at the variables thus read out (S1104).

Display image data generation device 0703 inputs the image data given from image input device 0701 to generate display image data on the basis of the inputted image data and the various variables the values of which are set by display image data generation operation processing unit 1007. The generated image data is outputted to display device 0704 and is displayed thereon as an image (S1105).

Next, image automatic display device 1004 detects an operation inputted by the user through viewer operation input device 1002 (S106). Image automatic display device 1004 is in a standby state until detection of the operation input. It is herein assumed that the input through the operation by the user is any one of three requests: an end request, an advancement request and a retreat request. If the end request is detected (YES in S1107), a series of processes ends (S1108).

If the advancement request is detected (YES in S1109), the value of variable N is increased by a value indicated by variable NS (S1110). If the value of variable N is larger than a value (value of variable NL−1) (YES in S111), the value of variable N is set at a result obtained by subtracting the value of variable NS from the value of variable NL (S1112) and, then, the processing proceeds to S1104. If the value of variable N is equal to or less than a value (value of variable NL−1) (NO in S1111), the processing proceeds to S1104.

If the input through viewer operation input device 1002 is not the advancement request (NO in S1109), the value of variable N is decreased by the value of variable NS (S1113). As a result, as long as the value of variable N is not equal to or more than 0 (NO in S1114), the value of variable N is set at 0 (S1115) and, then, the processing proceeds to S1104. If the value of variable N is equal to or more than 0 (YES in S1114), the processing proceeds to S1104 without changes.

Herein, the value of variable NS is 1; however, such a value may be an integer equal to or more than 1. Variable NS is not necessarily a constant, and may be varied depending on conditions as a parameter. For example, if the frequency of inputting the advancement request or the retreat request is increased per unit time, the value of variable NS is increased so as to increase the number of sets SEi to be skipped. If such an input operation is carried out, it can be assumed that set SEi that the user desires to apply for generating an image is registered prior to (or subsequent to) the current set. Therefore, when the number of sets SEi to be skipped is increased, it is possible to smoothly specify desired set SEi in automatic operation data 200.

The advancement request and the retreat request are divided into a plurality of kinds, respectively, so that the value of variable NS may be changed in accordance with the kind of a request inputted through an operation.

A list of the values of sets SEi of automatic operation data 200 is displayed on display device 0704 in order that the user who desires to view an image readily selects a desired set SEi, so that the user may perform an operation while confirming the list.

### Fourth Embodiment

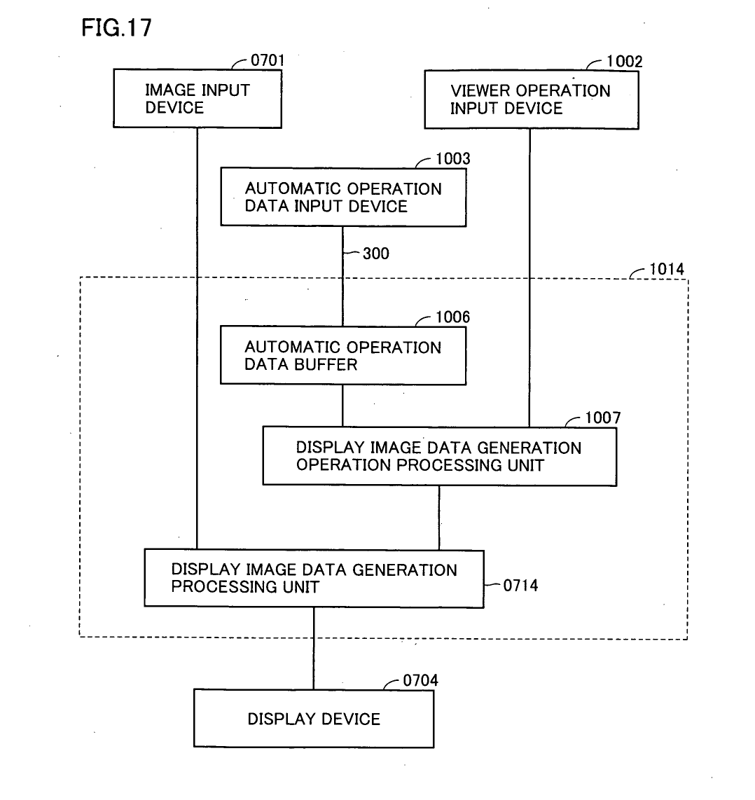

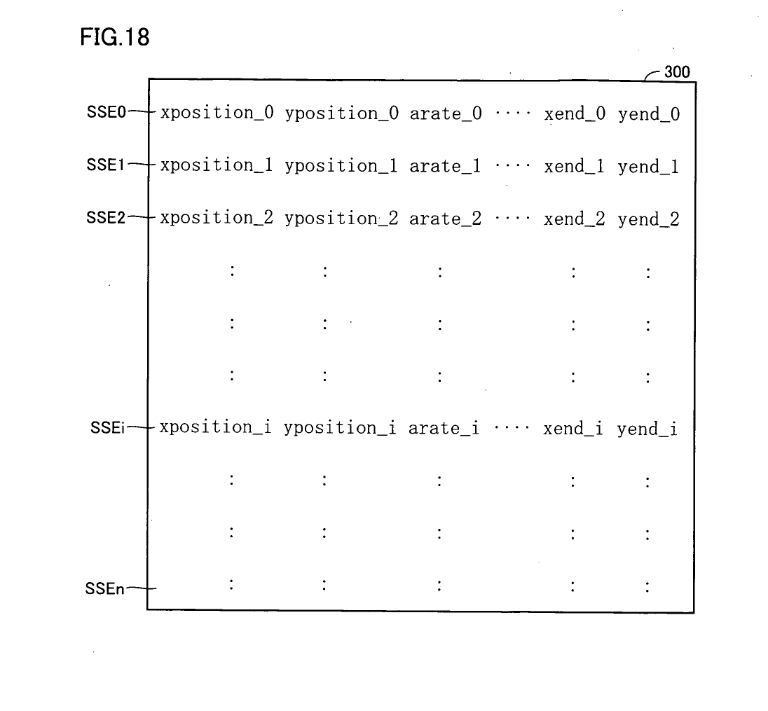

FIG. 17 shows a configuration of an image automatic display device 1014 according to a fourth embodiment. Image automatic display device 1014 is different from automatic image display device 1004 shown in FIG. 14 in the following points. That is, in image automatic display device 1014, automatic operation data 300 shown in FIG. 18 is inputted in place of automatic operation data 200 shown in FIG. 16, and display image data generation processing unit 0714 is provided in place of display image data generation device 0703. The other components of image automatic display device 1014 are similar to those shown in FIG. 14; therefore, specific description thereof will not be given here.

This embodiment adopts display image data generation processing unit 0714 according to the second embodiment; therefore, composition ratio orate between whole image data and partial image data can be automatically set at an optimal value on the basis of image data to be displayed. Accordingly, automatic operation data 300 given to image automatic display device 1014 is constituted by a plurality of sets SSEi containing no composition ratio orate as shown in FIG. 18. The structure of automatic operation data 300 is similar to that of automatic operation data 200 except the point that automatic operation data 300 contains no composition ratio orate; therefore, specific description thereof will not be given here. Processing procedures according to this embodiment are equal to those shown in FIG. 15.

As described above, the kind of the variable which is a core module for displaying an image on a screen and is operable by display image data generation device 0703 and display image data generation processing unit 0714 can be readily changed by the kind of the variable held by automatic operation data 200 and automatic operation data 300. Thus, there is no limitation concerning the kind of the variable treated in display image data generation device 0703 and display image data generation processing unit 0714.

It is sufficient that the values of the variables of designated sets SEi are read out from automatic operation data 200 and automatic operation data 300, respectively. Therefore, it is unnecessary to prepare automatic operation data 200 and automatic operation data 300 as independent data, respectively. For example, automatic operation data is previously contained in image data and such image data is given to the device, so that the automatic operation data may be supplied to the device.

As is clear from the third and fourth embodiments, even in the case of using any type of image automatic display data generation processing engine, the image automatic display device can utilize therein the engine with the use of the control parameters of the engine and variables given from automatic operation data 200 or 300.

For example, in the case of using an image automatic display device with simple function, such as an image automatic display device which simply alters the scale of a partial region of an image to be displayed, it is sufficient that the number of control parameters is decreased in conformity with the used image automatic display device. In contrast, in the case of using an image automatic display device with complicated function, it is sufficient that the number of control parameters is increased in conformity with the used image automatic display device.

### Fifth Embodiment

A fifth embodiment describes a display automatic operation data generation device which uses display image data generation device 0703 according to the first embodiment to thereby author automatic operation data.

The display automatic operation data generation device according to the fifth embodiment records, as automatic operation data, various parameter values given to control processing unit 0708 of display image data generation device 0703 according to the first embodiment used therein. The automatic operation data generated by the display automatic operation data generation device is used for automating the operation through a viewer. The corresponding viewer has therein display image data generation device 0703 according to the first embodiment. The viewer acts to read the automatic operation data and give the value of the automatic operation data thus read to control processing unit 0708 of display image data generation device 0703 according to the first embodiment. In this embodiment, display image data generation device 0703 according to the first embodiment is applied as a display image data generation processing engine; however, the present invention is not limited thereto. In other words, any display image data generation processing engine which is operable concerning the display of image data can be applied.

In the case of using an image automatic display device with simple function, such as an image automatic display device which does not overlap a whole image and a partial image on each other, but simply alters the scale of a partial region of an image to be displayed, the number of basic parameters (to be described later) of automatic operation data may be decreased in conformity with the used image automatic display device. In contrast, in the case of using an image automatic display device with complicated function, the number of basic parameters (to be described later) of the automatic operation data may be increased in conformity with the used image automatic display device.

The corresponding viewer reproduces the display intended by the generator with the use of the automatic operation data generated by display automatic operation data generation device according to this embodiment. In addition, since an attention portion can be indicated by an object such as a line segment, it is sufficient that the user pursues the reading of the portion indicated by the object such as the line segment.

The display automatic operation data generation device according to the fifth embodiment has the function of recording, as the automatic operation data, operation details such as operation procedures inputted to display image data generation device 0703 according to the first embodiment as described above, and the function of displaying, on display device 0704, the display image data outputted from display image data generation device 0703. With these functions, in the case where the user views the display image data generated by using the viewer, the user can generate automatic operation data while checking how the image is displayed.

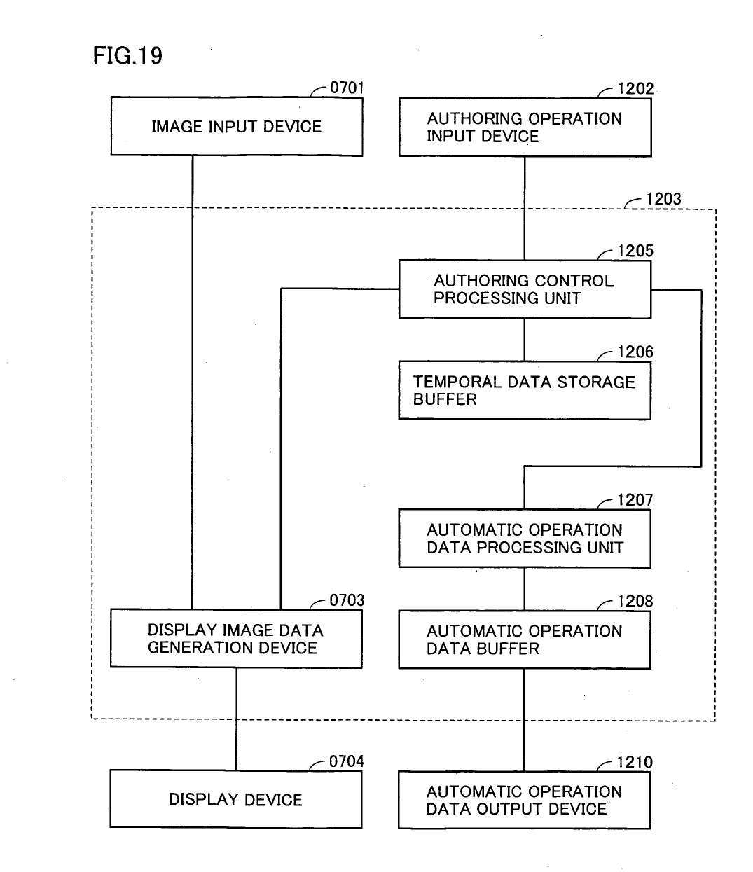

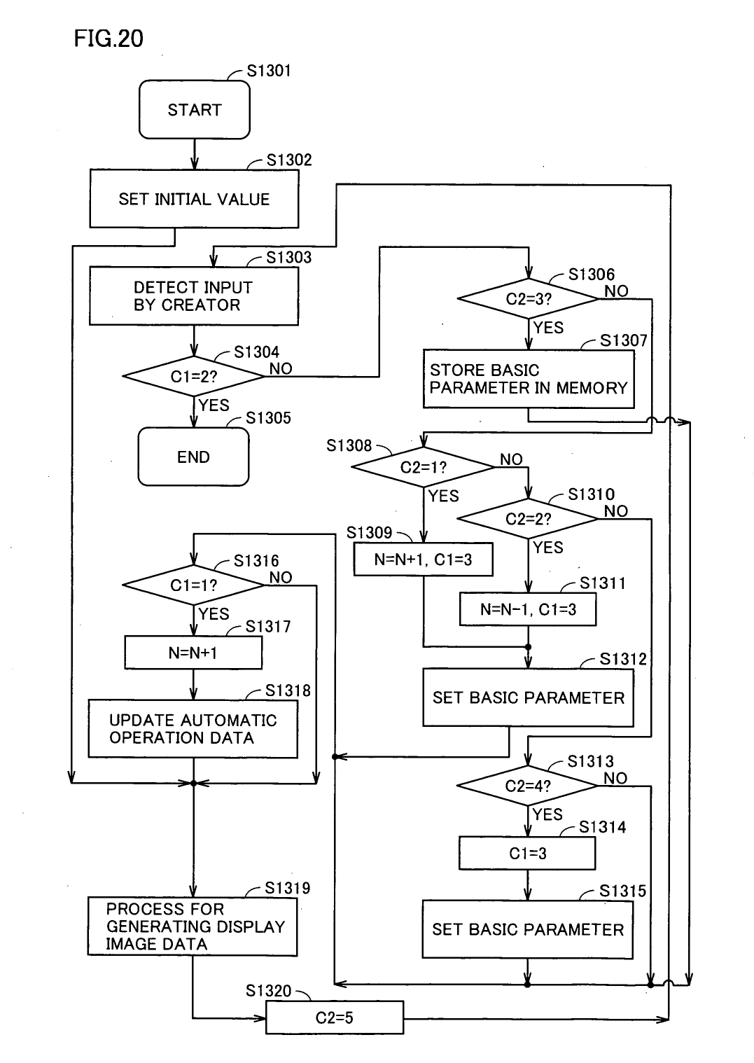

FIG. 19 shows a configuration of a display automatic operation data generation device 1203 according to the fifth embodiment. FIG. 20 shows processing procedures in display automatic operation data generation device 1203 according to the fifth embodiment.

With reference to FIG. 19, display automatic operation data generation device 1203 connects among image input device 0701, an authoring operation input device 1202, display device 0704 and an automatic operation data output device 1210. Display automatic operation data generation device 1203 receives the inputted image data from image input device 0701 and the generator operation information from authoring operation input device 1202, respectively, and outputs the output data to display device 0704 and automatic operation data to automatic operation data output device 1210, respectively.

Display automatic operation data generation device 1203 has therein an authoring control processing unit 1205, a temporal data storage buffer 1206, an automatic operation data processing unit 1207, an automatic operation data buffer 1208 and display image data generation device 0703 according to the first embodiment.

Authoring control processing unit 1205 reads out/writes data to/from temporal data storage buffer 1206, transmits/receives operation data to/from automatic operation data processing unit 1207, and outputs operation data to display image data generation device 0703.

Temporal data storage buffer 1206 stores operation data outputted from authoring control processing unit 1205.

Automatic operation data processing unit 1207 transmits/receives operation data to/from authoring control processing unit 1205, and reads out/writes data from/to automatic operation data buffer 1208.

Automatic operation data buffer 1208 stores the automatic operation data outputted from automatic operation data processing unit 1207.

Display image data generation device 0703 receives inputted image data from image input device 0701 and operation data from authoring control processing unit 1205, generates display image data with the use of the data thus received, and outputs the generated display image data to display device 0704.

Temporal data storage buffer 1206 and automatic operation data buffer 1208 are realized by RAMs such as a flash memory and hard disc 126. Authoring control processing unit 1205, automatic operation data processing unit 1207 and display image data generation device 0703 are realized by independent circuits, respectively. Alternatively, authoring control processing unit 1205, automatic operation data processing unit 1207 and display image data generation device 0703 may be constituted by virtual circuitry realized by, for example, arithmetic processing circuits of CPU 122 shown in FIG. 12, that is, a program.

In display automatic operation data generation device 1203 according to the fifth embodiment, the display image data generation device according to the first embodiment is used as display image data generation device 0703. However, any types of display image data generation device may be used as long as a display image data generation device to be used has the function of generating data to be displayed on display device 0704.

The parameters, which can be operated by operation data obtained through an operation of authoring operation input device 1202 by the generator of the display automatic operation data and given to display automatic operation data generation device 1203, are classified into basic parameters and authoring control parameters. The basic parameters are necessary to generate the display image data and are given to display image data generation device 0703. Authoring control processing unit 1205 refers to the authoring control parameters in order to carry out authoring control.

In display automatic operation data generation device 1203 according to the fifth embodiment, the image data generation device according to the first embodiment is used as display image data generation device 0703. Therefore, the basic parameters indicate positions (xposition, yposition) in the inputted image data on the left upper point of the partial image data, display magnification arate, partial image straight line presence/absence part_line, whole image straight line presence/absence whole_line, straight line start points (xstart, ystart), straight line end points (xend, yend), and composition ratio orate between the partial image data and the whole image data, respectively.

For example, as shown in FIGS. 10 and 11, at the time when the user views an image with the use of the viewer, the straight line is drawn for the purpose of designating a portion or a line where the generator desires the user to view.

Even when the display automatic operation data generation device has therein a display image data generation device different from display image data generation device 0703, a set of parameters inputted through authoring operation input device 1202 is altered so as to contain basic parameters suitable for the specification of the interior display image data generation processing unit, so that it is possible to respond to such a difference.

For example, if display automatic operation data generation device 1203 uses display image data generation device 0703 without the function of drawing a straight line, it is sufficient that parameters part_line, whole_line, xstart, ystart, xend and yend relating to the drawing of a straight line on the basic parameters are excluded from the set of basic parameters. Alternatively, if display image data generation device 0703 of display automatic operation data generation device 1203 additionally has a new function, the set of parameters inputted through authoring operation input device 1202 is altered so as to contain parameters for operating the new function in the set of basic parameters, so that it is possible to respond to such a new function.

Logics for recording the basic parameters in the automatic operation data are all basic parameters and are equal to each other. Accordingly, it is sufficient that a set of basic parameters is made in conformity with the inputted parameters of the display image data generation device.

Herein, in the automatic operation data, a set of basic parameters sent from authoring control processing unit 1205 to display image data generation device 0703 is recorded (saved) in a stroke as parameters for determining a display state at this time. Herein, the set of basic parameters thus recorded in a stroke is referred to as one step. Further, respective steps recorded in the automatic operation data are referred to as a 0th step, a first step, a second step, . . . , an ith step, . . . and an mth step, respectively, in accordance with a recording order. Moreover, authoring control parameters include a parameter C1 and a parameter C2.

Parameter C1 instructs an action for recording basic parameters and is set at the following values. Upon instructing ON of the recording action, parameter C1 is set at 1. Upon instructing OFF of the recording action, parameter C1 is set at 2. Upon instructing pause of the recording action, parameter C1 is set at 3. In display automatic operation data generation device 1203, when parameter C1 is set at 1, the change in the basic parameters by the operation by the generator through authoring operation input device 1202 is recorded in the automatic operation data. When parameter C1 is set at 2, the recording action ends and a series of programs ends. When parameter C1 is set at 3, the basic parameters are not recorded in the automatic operation data.

Parameter C2 is used in order to allow the generator to readily generate the automatic operation data, and is set at the following values. Upon instructing step advancement, parameter C2 is set at 1. Upon instructing step retreat, parameter C2 is set at 2. Upon instructing storage of the basic parameters, parameter C2 is set at 3. Upon instructing reading of the stored basic parameters, parameters C2 is set at 4. Upon instructing a default value, parameter C2 is set at 5.

When parameter C2 is set at 1 or 2, parameter C2 instructs to generate display image data by using the basic parameters of the step of the already generated automatic operation data. For example, in the case where improper operation procedures (steps) are recorded in the automatic operation data due to an erroneous operation or the like by the generator, an operation is carried out so that parameter C2 is set at 1 or 2. Thus, the automatic operation data returns to an initial portion where the improper operation procedures are recorded, and automatic operation data subsequent thereto can be regenerated.

When parameter C2 is set at 3, display automatic operation data generation device 1203 stores the basic parameters in temporal data storage buffer 1206.

When parameter C2 is set at 4, the stored basic parameters are read out from temporal data storage buffer 1206, and display image data is generated with the use of the basic parameters.

When parameter C2 is set at 5 which is a default value, parameter C2 is acted on nothing.

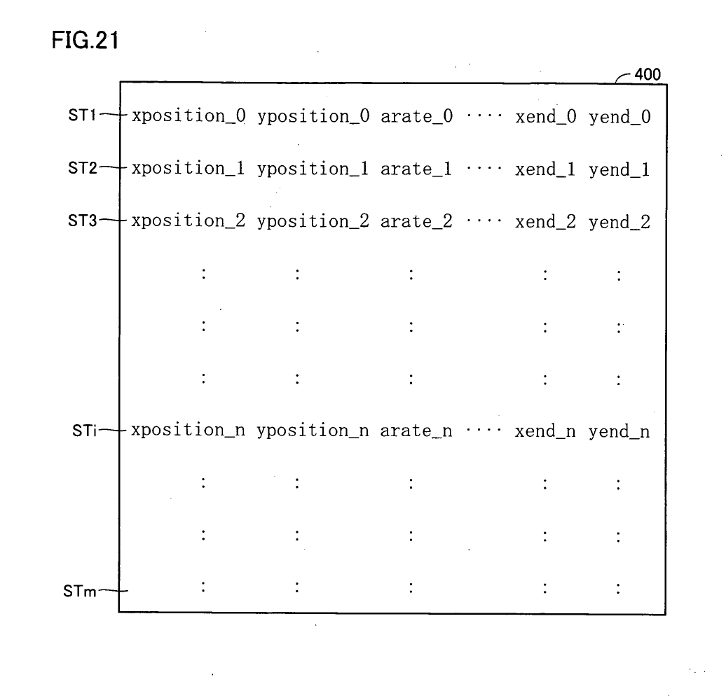

Automatic operation data 400 generated in display automatic operation data generation device 1203 according to the fifth embodiment has, for example, a format shown in FIG. 21, and contains ith steps STi (i=1, 2, 3, . . . , m). In each step STi, each parameter value is delimited with single spaces and a line break is inserted between steps STi. Thus, a value in a predetermined step STi of each parameter in automatic operation data 400 can be specified uniquely. The format of automatic operation data 400 is not limited to that shown in FIG. 21. The format may be a format in which a value in predetermined step STi of each parameter in automatic operation data 400 can be specified uniquely. In addition, automatic operation data 400 may be contained in image data as a header and the like of the image data. FIG. 21 shows one example of automatic operation data 400; however, the kind and the number of the parameters contained in automatic operation data 400 are not limited to those shown in FIG. 21.

In the processing procedures shown in FIG. 20, a parameter N is used as a parameter unique to an interior of the processing indicating the reading/writing position of automatic operation data 400. Parameter N instructs an order number indicated by a subscript i of step STi which is a current reading/writing target of automatic operation data 400.

With reference to the procedures shown in FIG. 20, description will be given of generation procedures of viewer automatic operation data 400 in display automatic operation data generation device 1203.

First, when the processing is started (S1301), authoring control processing unit 1205 sets initial values for various parameters (S1302). Then, display image data generation device 0703 generates display image data with the use of the inputted image data received from image input device 0701 at the start of the processing and the set initial values, and outputs the display image data to display device 0704. Therefore, image data thus generated is displayed on display device 0704 (S1319). For example, the initial values are set as follows: xposition=0, yposition=0, arate=1, part line=0, whole_line=0, xstart=0, ystart=0, xend=0, yend=0, orate=1, C1=2, C2=5, and N=0.

Next, authoring control processing unit 1205 detects an input by the generator through authoring operation input device 1202 (S1303). As a result of the detection, if the input by the generator indicates that C1=2 (instruction of recording OFF) (YES in S1304), the generation process of automatic operation data 400 ends (S1305). Otherwise (NO in S1304), determination whether the input by the generator indicates that C2=3 (instruction of basic parameter storage) is carried out (S1306). As a result of the determination, if the input by the generator indicates that C2=3, authoring control processing unit 1205 stores the values of the current various basic parameters in temporal data storage buffer 1206 (S1307) to determine whether or not the input by the generator indicates that C1=1 (instruction of recording ON) (S1316). As a result of the determination, if the input by the generator indicates that C1=1 (YES in S1316), authoring control processing unit 1205 increases the value of parameter N by 1, and gives the values of the current various basic parameters to automatic operation data processing unit 1207 (S1317). Automatic operation data processing unit 1207 writes the values of the current basic parameters to the values of parameters of an Nth step STN (N=1, 2, 3, . . . , i, . . . , m) of automatic operation data 400 in automatic operation data buffer 1208 (S1318).

Thereafter, authoring control processing unit 1205 gives the current basic parameters to display image data generation device 0703. Therefore, display image data generation device 0703 generates display image data with the use of the inputted image data and the given current basic parameters, and outputs the display image data to display device 0704. Thus, an image based on the image data is displayed on display device 0704 (S1319). Thereafter, authoring control processing unit 1205 sets that C2=5 (default value) (S1320), and the processing returns to the process for detecting the input by the generator (S1303).

On the other hand, if the input by the generator does not indicate that C1=1 (recording ON) (NO in S1316), automatic operation data 400 is not updated, and display image data is generated by the values of the current basic parameters and inputted image data; thus, image is displayed (S1319).

As described above, the generator can register the values of the various basic parameters to automatic operation data 400 and, simultaneously, can check an image of the display image data generated by the values of these basic parameters while displaying the image on the display device 0704. In addition, the generator does not register the values of the current basic parameters to automatic operation data 400, and can check an image based on the display image data generated by these values while displaying the image.

Accordingly, by checking the displayed image, the generator can determine whether or not the values of desired basic parameters are suitable for generating display image data for an intended image, irrespective of the registration.

If the input by the generator does not indicate that C2=3 (instruction of basic parameter storage) (NO in S1306), authoring control processing unit 1205 determines whether or not the input by the generator indicates that C2=1 (instruction of step advancement) (S1308). As a result of the determination, if it is determined that C2=1, authoring control processing unit 1205 increases the value of parameter N by 1 and sets that C1=3 (instruction of recording pause) (S1309). Then, automatic operation data processing unit 1207 reads out the values of the various basic parameters of Nth step STN from automatic operation data 400 stored in automatic operation data buffer 1208, and sets respective basic parameters for generating display image data at the respective values thus read out (S1312). Thereafter, processes subsequent to S1316 are carried out as described above.

On the other hand, if the input by the generator does not indicate that C2=1 (instruction of step advancement) (NO in S1308), authoring control processing unit 1205 determines whether or not the input by the generator indicates that C2=2 (instruction of step retreat) (S1310). As a result of the determination, if it is determined that C2=2, authoring control processing unit 1205 decreases the value of parameter N by 1 and sets that C1=3 (instruction of recording pause) (S1311). Then, processes subsequent to S1312 are carried out.

Accordingly, in automatic operation data 400 of automatic operation data buffer 1208, it is possible to check, through display device 0704, an image of the display image data generated with the use of the values of the basic parameters registered in immediately after (that is, N+1th) or immediately before (that is, N−1th) the current (that is Nth) basic parameters.

Therefore, the generator can check, through display device 0704, an image based on the image data generated with the use of the values of the various parameters of optional step STN registered in automatic operation data 400 currently.

On the other hand, if the input by the generator does not indicate that C2=2 (NO in S1310), authoring control processing unit 1205 determines whether or not the input by the generator indicates that C2=4 (instruction of reading of stored basic parameters) (S1313). As a result of the determination, if it is determined that C2=4 (YES in S1313), authoring control processing unit 1205 sets that C1=3 (instruction of recording pause) (S1314), reads out the values of the various parameters from temporal data storage buffer 1206, and sets the values of the various basic parameters thus read out at the current basic parameters, respectively (S1315). Thereafter, processes subsequent to S1316 are carried out. On the other hand, the input by the generator does not indicate that C2=4 (NO in S1313), processes subsequent to S1316 are carried out.

Accordingly, if the generator checks, through display device 0704, an image based on the display image data generated with the use of the values of the various basic parameters stored in temporal data storage buffer 1206 but not registered in automatic operation data 400 and, as a result, determines that a desired image is displayed, it is possible to instruct to formally register the values of the various basic parameters in automatic operation data 400.

As described above, by operating authoring operation input device 1202 to optionally set the values of control parameters C1 and C2, the generator can check, through display device 0704, an image based on display image data generated with the use of a set of basic parameters designated by these values of control parameters C1 and C2 (a set inputted by the generator through authoring operation input device 1202 or set STi registered in operation data 400). Simultaneously, in accordance with a result of the check, the generator can newly register the set in automatic operation data 400 and update step STN already registered in automatic operation data 400.

As described above, if control parameter C2 is set at 4, the stored basic parameters are read and display image data is generated with the use of these parameters. For example, when an image of a document in which characters are described in each lateral line is used as inputted image data, display image data of one line from left to right is generated for each line and display image data generation process is shifted to the next line. In such a case, the basic parameters are stored at a beginning position of each line, and the display image data is generated in accordance with the values of the basic parameters up to the end of the line. Thereafter, the stored basic parameters are read and, then, the process returns to the beginning position of the line. Thus, this becomes reference for inputting the display portion of the next line. For example, at the time when the display positions are moved discontinuously at the beginning of a line due to a change in line, it is possible to prevent the lateral positions (longitudinal positions in case of vertical writing) from being scattered every time a line is changed. This will be described with reference to the drawings.

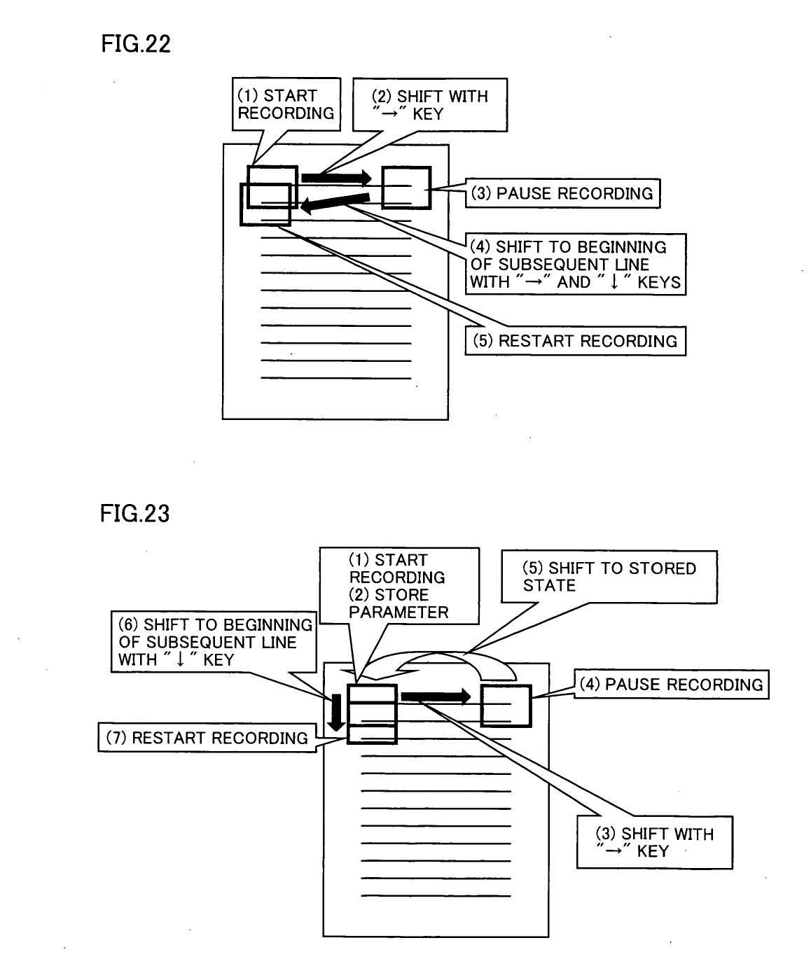

FIG. 22 shows an example of authoring procedures in the case of using no function of storing basic parameters. FIG. 23 shows an example of authoring procedures in the case of using the function of storing basic parameters. In FIGS. 22 and 23, there is generated display image data in which a first line of a document is displayed and a display region is shifted to a second line. Numbers (1), (2), . . . , (7) in enclosures in the figure denote procedures. In addition, bold rectangles in the figure denote regions displayed on display device 0704, and lines denote character strings.

In FIG. 22, the generator starts (recording ON) to record values of basic parameters at a beginning of a first line (procedure (1)) to generate display image data. Then, the generator operates a “→” key (not shown) of authoring operation input device 1202 to shift the display region in a line end direction (procedure (2)), pauses (recording pause) the recording of the values of the basic parameters at an end of the line (procedure (3)). When the display region is shifted to a beginning of a subsequent line through key operation (procedure (4)), the recording of the basic parameters is restarted (procedure (5)). Accordingly, coordinates of the beginning position of the second line deviates from those of the start position of the first line in a lateral direction. This is because the values of the basic parameters on the first line are not stored in the second line; therefore, the values of the basic parameters used for generating image data in the first line are not used for generating image data in the second line any more. Consequently, coordinates of the start positions in the lateral direction come apart every time a line is changed in the case of the example shown in FIG. 22. Therefore, it is difficult for the user to pursue the reading of a document based on the display image data thus generated.

In contrast, in FIG. 23, the generator starts (recording ON) to record values of basic parameters at a beginning of a first line to allow the beginning of the first line to store the values of the basic parameters (procedures (1) and (2)), and generates display image data with the use of the values of the basic parameters. Then, the generator operates the “→” key (not shown) of authoring operation input device 1202 to shift the display region in a line end direction (procedure (3)), and pauses (recording pause) the recording at an end of the line (procedure (4)). Thereafter, when the stored values of the basic parameters are read out, the display region shifts to the beginning of the first line indicated by the values of the basic parameter values thus read out (procedure (5)). The generator shifts the display region to a beginning of a subsequent line through key operation (procedure (6)). Thus, the recording of the basic parameters for the second line is started (procedure (7)). Accordingly, in FIG. 23, in order to instruct the beginning position of the second line after generation of the image data of the first line, the display region is returned to the beginning position of the first line with the use of the stored basic parameters, and shifts downward therefrom with the use of a “↓” key (not shown) of authoring operation input device 1202. Therefore, it is possible to correctly match the coordinates of beginning position of the first line with those of the beginning position of the second line in the lateral direction.

### Sixth Embodiment

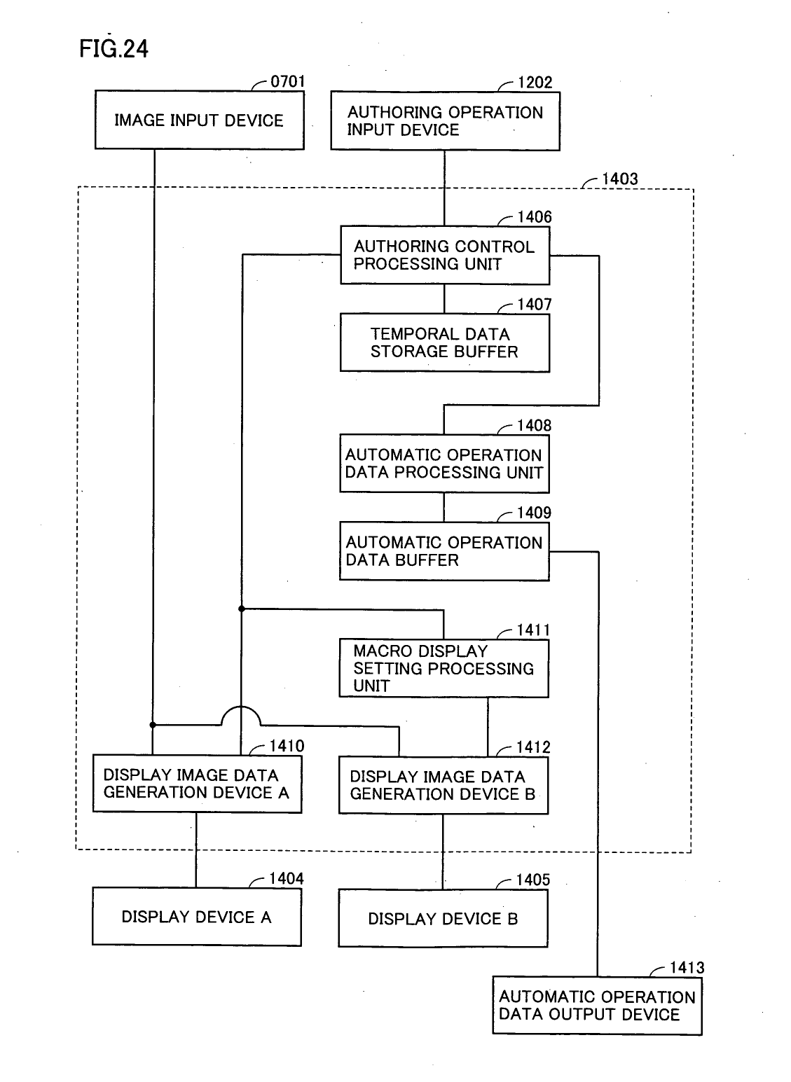

Next, description will be given of a sixth embodiment. FIG. 24 shows a configuration of a display automatic operation data generation device 1403 according to the sixth embodiment.

Display automatic operation data generation device 1203 according to the fifth embodiment displays only the image data generated with the use of step STN (hereinafter, referred to as basic data) to be a target for recording in automatic operation data 400. However, display automatic operation data generation device 1403 has a macro display function of furnishing, to the generator, a portion of an image to be a target for generation in an entire inputted image, in addition to the functions of display automatic operation data generation device 1203.

This macro display function allows to display an image generated on the basis of basic data actually recorded in automatic operation data 400 (equal to the display operation by display automatic operation data generation device 1203 according to the fifth embodiment) and, simultaneously, allows to display an image by the macro display function on another screen. Thus, it is possible to carry out an authoring operation while grasping the entirety of an inputted image such as a document.

For example, when basic data to generate the image shown in FIG. 5 or 6 is set, display automatic operation data generation device 1403 according to the sixth embodiment displays the image shown in FIG. 9 by the macro display function.

With reference to FIG. 24, display automatic operation data generation device 1403 connects among image input device 0701, authoring operation input device 1202, a display device A 1404, a display device B 1405 and an automatic operation data output device 1413. Display device A 1404, display device B 1405 and automatic operation data output device 1413 may be individual display devices or may be separate windows displayed by identical display automatic operation data generation device 1403. These separate windows may be displayed on one screen concurrently or may be displayed on different screens, respectively.

Display automatic operation data generation device 1403 receives inputted image data from image input device 0701 and generator operation information from authoring operation input device 1202, respectively, and outputs output data to display device A 1404 and display device B 1405, respectively.

Display automatic operation data generation device 1403 has therein an authoring control processing unit 1406, a temporal data storage buffer 1407, an automatic operation data processing unit 1408, an automatic operation data buffer 1409, a display image data generation device A 1410, a macro display setting processing unit 1411 and a display image data generation device B 1412.

Authoring control processing unit 1406 reads out/writes data from/to temporal data storage buffer 1407, transmits/receives operation data to/from automatic operation data processing unit 1408, and outputs the operation data to display image data generation processing unit A 1410 and macro display setting processing unit 1411.

Temporal data storage buffer 1407 stores the operation data outputted from authoring control processing unit 1406. Automatic operation data processing unit 1408 transmits/receives the operation data to/from authoring control processing unit 1406, and reads out/writes data from/to automatic operation data buffer 1409.

Automatic operation data buffer 1409 stores automatic operation data 400 outputted from automatic operation data processing unit 1408.

Macro display setting processing unit 1411 receives the operation data from authoring control processing unit 1406, and outputs the operation data to display image data generation device B 1412.

Display image data generation device A 1410 receives the inputted image data from image input device 0701 and the operation data from authoring control processing unit 1406, respectively, to generate display image data, and outputs the display image data to display device A 1404.

Display image data generation device B 1412 receives the inputted image data from image input device 0701 and the operation data from macro display setting processing unit 1411, respectively, to generate display image data, and outputs the display image data to display device B 1405.

Temporal data storage buffer 1407 and automatic operation data buffer 1409 are realized by RAMs such as a flash memory and hard disc 126. Authoring control processing unit 1406, automatic operation data processing unit 1408, display image data generation processing device A 1410, macro display setting processing unit 1411 and display image data generation device B 1412 are realized by, for example, independent circuits. For example, these parts may be realized by virtual circuitry realized by arithmetic processing circuits of CPU 122, that is, a program.

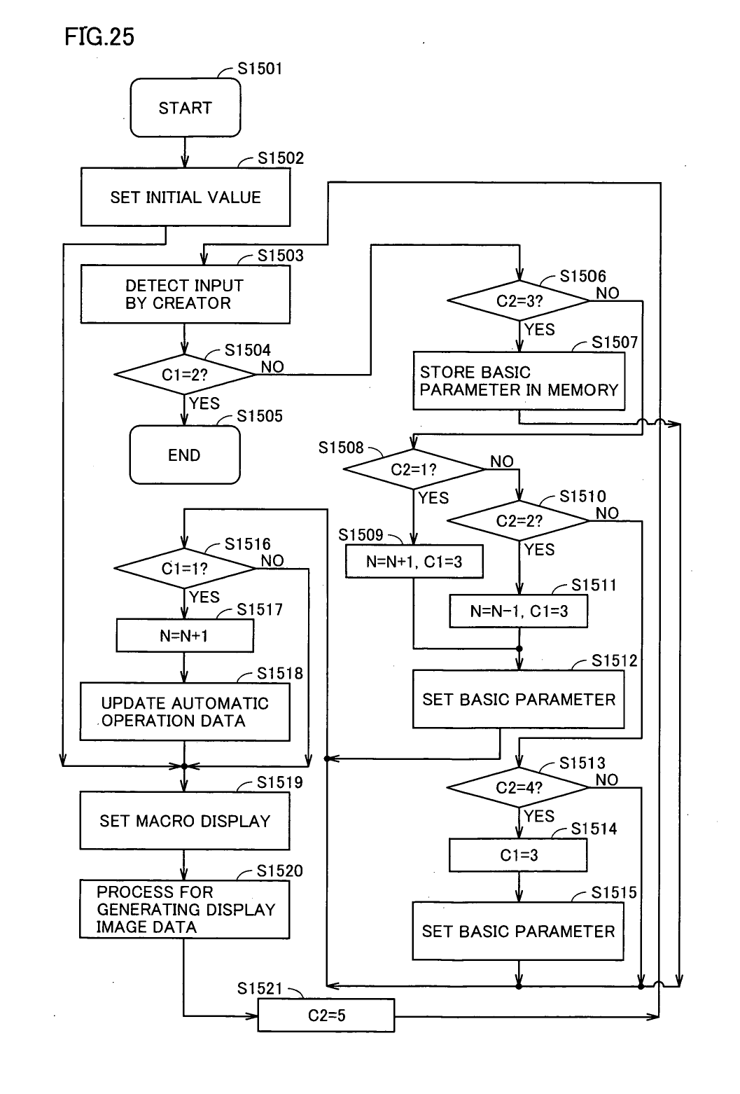

FIG. 25 shows processing procedures for generating automatic operation data in display automatic operation data generation device 1403. In accordance with the procedures shown in FIG. 25, description will be given of processes for generating automatic operation data according to this embodiment. Herein, definitions of basic parameters, authoring control parameters and parameters N used in this embodiment are equal to those in the fifth embodiment. It is assumed herein that automatic operation data buffer 1409 previously stores automatic operation data 400.

First, when processing is started (S1501), authoring control processing unit 1406 sets initial values of various parameters (S1502). For example, the initial values are set as follows: xposition=0, yposition=0, arate=1, part_line=0, whole_line=0, xstart=0, ystart=0, xend=0, yend=0, orate=1, C1=2, C2=5, and N=0.

Macro display setting processing unit 1411 sets only the value of composition ratio orate at 0 in the parameters given from authoring control processing unit 1406, and gives these parameters to display image data generation device B 1412 (S1519). Display image data generation device B 1412 generates display image data with the use of the image data inputted through image input device 0701 and the values of the parameters given from macro display setting processing unit 1411, and outputs the display image data to display device B 1405 on which an image is displayed. In parallel, display image data generation device A 1410 generates display image data with the use of the image data inputted through image input device 0701 and the values of the parameters given from authoring control processing unit 1406, and outputs the display image data to display device A 1404 on which an image is displayed (S1520).

Next, authoring control processing unit 1406 sets that C2=5 (default value) (S1521) to detect the input by the generator through authoring operation input device 1202 (S1503). If the input by the generator indicates that C1=2 (recording OFF) (YES in S1504), the processing ends (S1505).

If the input by the generator does not indicate that C1=2 (NO in S1504), authoring control processing unit 1406 determines whether or not the input by the generator indicates that C2=3 (storage of basic parameters) (S1506). If the input by the generator indicates that C2=3 (YES in S1506), authoring control processing unit 1406 stores the basic parameters in temporal data storage buffer 1407 (S1507) and, then, determines whether or not the input by the generator indicates that C1=1 (recording ON) (S1516).

If the input by the generator indicates that C1=1 (YES in S1516), authoring control processing unit 1406 increases the value of parameter N by 1 (S1517), sets the values of the basic parameters of Nth step STN of automatic operation data 400 at the values of the current basic parameters to update automatic operation data 400, and sends the current basic parameters to display image data generation device A 1410 and display image data generation device B 1411(S1518). Thereafter, processes in S1519 and S1520 are carried out as described above. Authoring control processing unit 1406 sets that C2=5 (default value) (S1521), and the processing returns to the process for detecting the input by the generator (S1503). If the input by the generator does not indicate that C1=1 (NO in S1516), automatic operation data 400 is not updated, and the process for generating the display image data (S1519) is carried out.

If the input by the generator does not indicate that C2=3 (storage of basic parameter) (NO in S1506), authoring control processing unit 1406 determines whether or not the input by the generator indicates that C2=1 (step advancement) (S1508). If it is determined that C2=1, authoring control processing unit 1406 increases the value of parameter N by 1, and sets that C1=3 (recording pause). Further, automatic operation data processing unit 1408 reads out the values of Nth step STN of automatic operation data 400 stored in automatic operation data buffer 1409, and sets the values of the current basic parameters at the values thus read out, respectively (S1509, S1512). Thereafter, the processes in and subsequent to S1516 are carried out.

If the input by the generator does not indicate that C2=1 (step advancement) in S1508, authoring control processing unit 1406 determines whether or not the input by the generator indicates that C2=2 (step retreat) (S1510). If it is determined that C2=2 (YES in S1510), authoring control processing unit 1406 decreases the value of parameter N by 1 and sets that C1=3 (recording pause), and the processes in and subsequent to S1512 are carried out.

If the input by the generator does not indicate that C2=2 (NO in S1510), authoring control processing unit 1406 determines whether or not the input by the generator indicates that C2=4 (reading of stored basic parameters) (SI 513). If it is determined that C2=4 (YES in S1513), authoring control processing unit 1406 sets that C1=3 (recording pause), reads out the values of the basic parameters from temporal data storage buffer 1407, and sets the values of the current basic parameters at the values thus read out, respectively (S1515). Thereafter, the processes in and subsequent to S1516 are carried out. If the input by the generator does not indicate that C2=4 (NO in S1513), the processes in and subsequent to S1516 are carried out.

According to display automatic operation data generation device 1403 described above, the generator can check, through display device A 1404, the image (image shown in FIG. 5 or 6) of image data generated with the use of the values of the basic parameters to be a target for registration in automatic operation data 400 or the values of the basic parameters of step STN already registered in automatic operation data 400 and the inputted image data. Simultaneously, the generator can check, through display device B 1405, the image (image shown in FIG. 9) of a portion to be a target for generation in the image of the inputted image data. Therefore, the generator can correctly determine whether or not the basic parameters used for generation of the image data displayed on display device A 1404 are desirable values, on the basis of a result of the check.

Each of the aforementioned embodiments is applicable by treating a document (document data) for a word processor, a text editor, a draw tool and the like as an image upon displaying such a document.

In addition, it is unnecessary to carry out an enlargement/reduction process of a document containing object data such as font in an imaging process. If there is object data such as font having the almost similar resolution, the object data may be used as an alternate.

The device according to each embodiment can be incorporated for use in various terminals such as a personal computer, a mobile telephone, a PDA and an electronic block device and various computer-controlled home electric appliances having the function of displaying information.

### Seventh Embodiment

The processing functions of each of the aforementioned embodiments are realized by a program. This embodiment describes that the program is stored in a computer-readable recording medium.

In this embodiment, such a recording medium may be a program medium such as a memory required for carrying out processing in the computer shown in FIG. 2, for example, memory 124 or may be a program medium readable in such a manner that there is provided a program read device such as a magnetic tape device or CD-ROM drive device 140 as an external storage device and a magnetic tape or CD-ROM 142 is inserted thereto as a recording medium. In any of the cases, the stored program may be executed by accessing of CPU 122. Alternatively, in any of the cases, the program is read out once, and the program thus read out is loaded onto the predetermined program storage area shown in FIG. 2, for example, the program storage area of memory 124 and is read out by CPU 122 to be executed. It is assumed herein that this program for loading is previously stored in the computer.

The aforementioned program medium is a recording medium configured separably from a computer main body. Examples thereof may include: tape-based media such as a magnetic tape and a cassette tape; disc-based media such as magnetic discs including FD 132 and hard disc 126, and optical discs including CD-ROM 142, an MO (Magnetic Optical Disc), an MD (Mini Disc) and a DVD (Digital Versatile Disc); card-based media such as an IC card (including a memory card) and an optical card; and media supporting a fixed program including a semiconductor memory by a mask ROM, an EPROM (Erasable and Programmable ROM), an EEPROM (Electrically EEPROM) or a flash ROM.

In this embodiment, since the computer shown in FIG. 2 adopts a configuration connectable to communication network 182 including the Internet, the medium may support in flux a program downloaded via communication network 182. In the case where the program is downloaded via communication network 182, the program for downloading may be previously stored in the computer main body or may be previously installed in the computer main body from another recording medium.

Herein, the details stored in the recording medium is not limited to the program, but may be data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A device for generating data to be displayed on a screen, comprising:
a display image data generation unit to generate display image data to be displayed with the use of inputted image data;
an automatic operation data input unit to input automatic operation data previously prepared for operating the generation of said display image data; and
a display image data generation operation processing unit to control the generation process in said display image data generation unit with the use of said automatic operation data inputted through said automatic operation data input unit.

2. The display data generation device according to claim 1, wherein said automatic operation data contains data instructing said display image data generation unit to draw a line segment on a predetermined range in an image of said display image data.

3. The display data generation device according to claim 1, wherein said automatic operation data contains data instructing said display image data generation unit to extract, for said display image data, image data of a predetermined region in an image of said inputted image data.

4. The display data generation device according to claim 3, wherein said automatic operation data contains data instructing to enlarge or reduce, at a predetermined magnification, an image of image data of said predetermined region to be extracted.

5. The display data generation device according to claim 1, wherein
said display image data generation unit includes:
a partial image data generation processing unit to cut, from said inputted image data, data of a region designated on the basis of region designation data contained in said automatic operation data to enlarge or reduce a size of the cut data on the basis of size data contained in said automatic operation data and to generate partial image data;
a whole image data generation processing unit to enlarge or reduce a size of said inputted image data on the basis of said size data and to generate whole image data; and
a superposition composition processing unit to generate said display image data by superposition composition of said whole image data and partial image data thus generated.

6. The display data generation device according to claim 5, wherein said display image data thus generated additionally contains a line segment drawn on a range designated on the basis of range designation data contained in said automatic operation data.

7. The display data generation device according to claim 5, wherein said display image data thus generated additionally contains image data indicative of a position corresponding to said partial image data in said whole image data.

8. The display data generation device according to claim 1, wherein said automatic operation data contains a set of a plurality of kinds of data, and said display image data generation operation processing unit selects, from said automatic operation data, a data set to be applied to said generation process on the basis of an operation by a user.

9. The display data generation device according to claim 1, wherein said automatic operation data is contained in said inputted image data.

10. A method for generating data to be displayed on a screen, comprising:
a display image data generation step of generating display image data to be displayed with the use of inputted image data;
an automatic operation data input step of inputting automatic operation data previously prepared for operating the generation of said display image data; and
a display image data generation operation processing step of controlling the generation process in said display image data generation step with the use of said automatic operation data inputted in said automatic operation data input step.

11. A display data generation program for allowing a computer to execute a method for generating data to be displayed on a screen, wherein
said method comprises:
a display image data generation step of generating display image data to be displayed with the use of inputted image data;
an automatic operation data input step of inputting automatic operation data previously prepared for operating the generation of said display image data; and
a display image data generation operation processing step of controlling the generation process in said display image data generation step with the use of said automatic operation data inputted in said automatic operation data input step.

12. A computer-readable recording medium containing a program for allowing a computer to execute a method for generating data to be displayed on a screen, wherein
said method comprises:
a display image data generation step of generating display image data to be displayed with the use of inputted image data;
an automatic operation data input step of inputting automatic operation data previously prepared for operating the generation of said display image data; and
a display image data generation operation processing step of controlling the generation process in said display image data generation step with the use of said automatic operation data inputted in said automatic operation data input step.

13. A device for generating display automatic operation data recording therein a basic parameter set containing one or more basic parameters each referred to for operating generation of display image data from inputted image data, said device comprising:
an authoring control processing unit to determine respective values of the basic parameters of said basic parameter set and respective values of one or more control parameters of an authoring control parameter set in accordance with an external input; and
an automatic operation data processing unit to control reading out of said basic parameter set from said display automatic operation data or writing of said determined values to the respective basic parameters of said basic parameter set of said display automatic operation data, in accordance with the values of the respective control parameters of said authoring control parameter set.

14. The display automatic operation data generation device according to claim 13, wherein
in the case where said display image data is partial image data of said inputted image data, said basic parameter set contains a basic parameter for designating said partial image data of said inputted image data.

15. The display automatic operation data generation device according to claim 14, wherein
in the case where said display image data is image data that whole image data of said inputted image data and partial image data of said inputted image data are overlapped with each other, said basic parameter set contains a basic parameter for designating a composition ratio of the overlap of said whole image data and said partial image data.

16. The display automatic operation data generation device according to claim 13, wherein
in the case where said display image data is image data for displaying an object in the corresponding display image, said basic parameter set contains a basic parameter for designating a display position of said object in the display image.

17. The display automatic operation data generation device according to claim 13, wherein said authoring control parameter set contains a writing presence/absence control parameter for instructing whether or not said determined value is written to each basic parameter of said basic parameter set of said display automatic operation data.

18. The display automatic operation data generation device according to claim 17, wherein
said authoring control parameter set contains, among said one or more basic parameter sets already recorded in said display automatic operation data, said control parameter for instructing a target basic parameter set to be a target for reading out or writing by said automatic operation data processing unit,
in the case where said writing presence/absence control parameter instructs that said determined value is not written, said automatic operation data processing unit reads out, from said automatic operation data, said basic parameter set instructed by said target basic parameter set, and
respective values of said basic parameters of said basic parameter set read out by said automatic operation data processing unit are referred to in order to operate the generation of said display image data.

19. The display automatic operation data generation device according to claim 18, wherein
when said plurality of basic parameter sets are already recorded in said display automatic operation data sequentially on a step basis, said control parameter for instructing said target basic parameter set is a movement instruction parameter for instructing a step positioned prior to or subsequent to said target basic parameter set of a current step to move to said basic parameter set, and
in the case where said authoring control processing unit successively determines the same value specific times or more on said movement instruction parameter, said automatic operation data processing unit increases the number of moving steps per once.

20. A method for generating display automatic operation data recording therein a basic parameter set containing one or more basic parameters each referred to for operating generation of display image data from inputted image data, said method comprising:
an authoring control processing step of determining respective values of basic parameters of said basic parameter set and respective values of one or more control parameters of an authoring control parameter set in accordance with an external input; and
an automatic operation data processing step of controlling reading out of said basic parameter set from said display automatic operation data or writing of said determined values to the respective basic parameters of said basic parameter set of said display automatic operation data, in accordance with the values of the respective control parameters of said authoring control parameter set.

21. A display automatic operation data generation program for allowing a computer to execute a method for generating display automatic operation data recording therein a basic parameter set containing one or more basic parameters each referred to for operating generation of display image data from inputted image data, wherein
said method comprises:
an authoring control processing step of determining respective values of basic parameters of said basic parameter set and respective values of one or more control parameters of an authoring control parameter set in accordance with an external input; and
an automatic operation data processing step of controlling reading out of said basic parameter set from said display automatic operation data or writing of said determined values to the respective basic parameters of said basic parameter set of said display automatic operation data, in accordance with the values of the respective control parameters of said authoring control parameter set.

22. A computer-readable recording medium containing a program for allowing a computer to execute a method for generating display automatic operation data recording therein a basic parameter set containing one or more basic parameters each referred to for operating generation of display image data from inputted image data, wherein
said method comprises:
an authoring control processing step of determining respective values of basic parameters of said basic parameter set and respective values of one or more control parameters of an authoring control parameter set in accordance with an external input; and
an automatic operation data processing step of controlling reading out of said basic parameter set from said display automatic operation data or writing of said determined values to the respective basic parameters of said basic parameter set of said display automatic operation data, in accordance with the values of the respective control parameters of said authoring control parameter set.

23. The display data generation device according to claim 5, wherein said superposition composition processing unit generates said display image data by superposition composition of said whole image data and said partial image data at a composition ratio determined on the basis of said partial image data.

24. The display data generation device according to claim 23, wherein said composition ratio is determined on the basis of a pixel value of said partial image data.

25. The display data generation device according to claim 23, wherein said composition ratio is determined on the basis of an amount of edges detected from said partial image data.

26. The display data generation device according to claim 23, wherein said composition ratio is determined on the basis of an amount of characters detected from said partial image data.
